(19) United States
(12) Patent Application Publication
(10) Pub. No.: US 2021/0272208 A1
(43) Pub. Date: Sep. 2, 2021

(54) System and Method for Predicting Total Loss of a Vehicle Prior to a Crash

(71) Applicant: STATE FARM MUTUAL AUTOMOBILE INSURANCE COMPANY, Bloomington, IL (US)

(72) Inventors: William J. Leise, Normal, IL (US); Craig M. Main, Hagerstown, MD (US)

(21) Appl. No.: 15/277,200

(22) Filed: Sep. 27, 2016

Related U.S. Application Data
(60) Provisional application No. 62/337,461, filed on May 17, 2016.

(51) Int. Cl. G06Q 40/08; G07C 5/00; B60R 21/00

(52) U.S. Cl. CPC G06Q 40/08; B60R 2021/0027; B60R 21/00; G07C 5/008

(57) ABSTRACT

A system, and method facilitate treatment of a damaged vehicle by gathering pre-crash information before the vehicle is damaged in a collision, determining a treatment complexity level before the vehicle collision based upon the pre-crash information, selecting a treatment facility for treating the vehicle, and requesting transport of the damaged vehicle from the crash site to a treatment facility. Auto claim data may be used to train a machine language program to identify or predict vehicles that are prone, or predisposed, to being classified as a “total loss” in the event of a vehicle collisions, such as based upon make, model, age, miles, etc. Vehicle characteristic data for a vehicle involved in a vehicle collision may subsequently be input into the trained machine language program to predict whether the vehicle is a total loss, and if so, total loss processing may be expedited without visual human inspection of the vehicle.

### CROSS-REFERENCE TO RELATED APPLICATIONS

This claims the benefit of U.S. Provisional Patent Application No. 62/337,461, entitled “System and Method for Predicting Total Loss of a Vehicle Prior to a Crash” and filed on May 17, 2016, the disclosure of which is hereby incorporated herein by reference in its entirety.

### TECHNICAL FIELD

The present disclosure generally relates to a system and a method for predicting a total loss of a vehicle prior to being damaged in a crash and, more particularly, to predicting a total loss of the vehicle and facilitating transportation of the vehicle to an appropriate salvage treatment facility when the vehicle is damaged in a crash irrespective of actual damage to the vehicle.

### BACKGROUND

Every year, vehicles are involved in collisions that result in varying amounts of damage to the vehicle. If the damaged vehicle is insured, an insurance claim is usually filed shortly after the collision. The damaged vehicle is typically brought to a location where an appraisal or assessment of the damage is made. Depending on the extent of the damage and the treatment facility where the damaged vehicle was brought, the damaged vehicle may then need to be further transported to a different treatment facility that is capable of performing the necessary repairs, or in the case where the damage is too costly to repair, to a salvage or a scrap facility. Additional time and costs are incurred when the damaged vehicle is brought to a first location for the initial appraisal, another location for storage and then to a subsequent location for the repair, salvage or scrapping.

### SUMMARY

The present embodiments may relate to predicting “total loss” vehicles. By predicting which vehicles are prone to total loss (i.e., the cost of treating the damaged vehicle is within a particular percentage of the value of the vehicle) before damage occurs or a claim is filed, total loss cycle time and cost may be reduced. For example, if it is determined that a vehicle is likely to be a total loss, both the insurer and the insured may reduce the time and cost involved to currently process an insurance claim. In particular, it may be assumed at the time of the first notice of loss (e.g., the time an insurance claim is made) that the vehicle is a total loss irrespective of the actual damage to the vehicle. As such, there may be reduced need for time and cost associated with appraisal, storage, transportation, repair, etc. Further, the insurance claim may be processed more quickly, thereby expediting the insurance settlement (payout) to the insured.

Exemplary systems and methods for treating and/or routing a vehicle damaged in a crash are herein described. In accordance with a first exemplary aspect of the invention, a method implemented on a computer system for treating a vehicle damaged in a crash may include (1) receiving pre-crash information about the vehicle; (2) determining a treatment complexity level associated with treating the vehicle after a crash based upon the received pre-crash information; (3) selecting a treatment facility for treating the vehicle based upon the determined treatment complexity level; and/or (4) transmitting information associated with transporting the damaged vehicle to the selected treatment facility. The treatment complexity level may include a value of the vehicle and a price schedule for treating the damaged vehicle, and treating the damaged vehicle may include repairing, salvaging, cannibalizing, or scrapping the damaged vehicle. The method may include additional, less, or alternate actions, including those discussed elsewhere herein.

In accordance with a second exemplary aspect of the invention, a method implemented on a computer system for processing a vehicle damaged in a crash may include (1) receiving pre-crash information about the vehicle; (2) determining whether a likelihood of a total loss of the damaged vehicle is greater than a predetermined threshold based upon the received pre-crash information; (3) receiving notice of the vehicle being damaged in a crash, the notice comprising an insurance claim for the damage to the vehicle; and/or (4) automatically offering an insurance settlement for an insured value of the damaged vehicle if the likelihood of a total loss of the damaged vehicle is greater than the predetermined threshold. The total loss of the damaged vehicle may include a cost of treating the damaged vehicle based upon a price schedule for treating the damaged vehicle being greater than a predetermined percentage of a value of the vehicle independent of a severity of actual damage after the vehicle is damaged in a crash, and the insurance settlement may include a value for a total loss of the vehicle independent of the severity of actual damage after the vehicle is damaged in the crash. The method may include additional, less, or alternate actions, including those discussed elsewhere herein.

In accordance with a third exemplary aspect of the invention, a computer system for treating a vehicle damaged in a crash may include: (1) a first computing device including one or more processors; (2) one or more sensors operatively coupled to the one or more processors of the first computing device, the one or more sensors adapted to monitor operating information of the vehicle and facilitate providing pre-crash information of the vehicle to the first computing device; (3) a first communication module operatively coupled to the first computing device and wirelessly transmitting the pre-crash information to a second computing device, the second computing device including one or more processors; (4) one or more memory devices operatively coupled to the one or more processors of the second computing device, the one or more memory devices of the second computing device storing executable instructions that, when executed by the one or more processors of the second computing device before the vehicle is damaged in a crash, cause the computer system to evaluate the pre-crash information and determine a treatment complexity level associated with treating the vehicle after a crash based upon pre-crash information; and/or (5) a second communication module operatively coupled to the second computing device and adapted to transmit information associated with transporting the damaged vehicle to a selected treatment facility, wherein selection of the treatment facility is based upon the treatment complexity level. The treatment complexity level may include a value of the vehicle and a price schedule for treating the damaged vehicle, wherein treating the damaged vehicle may include repairing, salvaging, cannibalizing, or scrapping the damaged vehicle. The computer system may include additional, less, or alternate functionality, including that discussed elsewhere herein.

In accordance with a third exemplary aspect of the invention, a computer system for treating a vehicle damaged in a crash may be provided. The computer system may include (1) a computing device including one or more processors; (2) a memory operatively coupled to the one or more processors, the memory adapted to store executable instructions that, when executed by the one or more processors before the vehicle is damaged in a crash, cause the computer system to determine a treatment complexity level associated with treating the vehicle after a crash based upon pre-crash information; (3) one or more sensors operatively coupled to the one or more processors adapted to monitor operating information of the vehicle, the one or more sensors capable of gathering the pre-crash information of the vehicle before the vehicle is damaged in a crash; (4) an analyzer operatively coupled to the one or more processors adapted to evaluate the pre-crash information of the damaged vehicle with a compilation of collision data of a vehicle type that includes the damaged vehicle, and/or (5) a communication module operatively coupled to the one or more processors adapted to transmit information associated with transporting the damaged vehicle to a selected treatment facility, wherein selection of the treatment facility is based upon the treatment complexity level. The treatment complexity level including a value of the vehicle and a price schedule for treating the damaged vehicle, wherein treating the damaged vehicle may include repairing, salvaging, cannibalizing, or scrapping the damaged vehicle.

In further accordance with any one or more of the foregoing first, second, third and fourth exemplary aspects, a method and computer system may further include any one or more of the following preferred forms.

In one form, determining a treatment complexity level may include evaluating whether a likelihood of a total loss of the damaged vehicle is greater than a predetermined threshold based upon the received pre-crash information, and selecting a treatment facility may include selecting a treatment facility for scrapping or salvaging the damaged vehicle if the likelihood of a total loss of the damaged vehicle is greater than the predetermined threshold. The total loss of the damaged vehicle may include the cost of treating the damaged vehicle being greater than a predetermined percentage of the value of the vehicle independent of a severity of actual damage after the vehicle is damaged in a crash.

In another form, the computer-implemented method may include receiving crash information about the damaged vehicle, determining a post-crash treatment complexity level associated with treating the damaged vehicle based upon the received crash information if the likelihood of the total loss of the damaged vehicle is less than the predetermined threshold, and selecting a treatment facility for treating the vehicle based upon the determined post-crash treatment complexity level.

In another form, the price schedule for treating the damaged vehicle may include one or more of a storage cost for storing the damaged vehicle, a rental cost while the damaged vehicle is being treated, and a time duration for completing treatment of the vehicle. The pre-crash information may include one or more of sensor data from the vehicle, telematics data about the vehicle, the value of the vehicle, the make of the vehicle, the model of the vehicle, the year of manufacture of the vehicle, images of the vehicle and past claim data about comparable vehicles damaged in a crash. The price schedule for treating the damaged vehicle may be based upon past claim data for treating comparable vehicles damaged in a crash. The value of the vehicle may include the actual cash value of the vehicle. Additionally or alternatively, the method may include selecting a treatment facility for scrapping the damaged vehicle if the likelihood of a total loss of the damaged vehicle is greater than the predetermined threshold, and transmitting information associated with transporting the damaged vehicle to the selected treatment facility.

### BRIEF DESCRIPTION OF THE DRAWINGS

The figures described below depict various aspects of the systems and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a general overview of an exemplary vehicle treatment system for treating a vehicle damaged in a crash;

FIG. 2A depicts an exemplary vehicle treatment process capable of being implemented in the vehicle treatment system illustrated in FIG. 1 in accordance with the presently described embodiments;

FIG. 2B depicts a further exemplary vehicle treatment process capable of being implemented in the vehicle treatment system illustrated in FIG. 1 in accordance with the presently described embodiments;

FIG. 3 depicts an exemplary computer-implemented method for gathering or receiving crash information in accordance with the presently described embodiments;

FIG. 4A depicts an exemplary computer-implemented method for estimating the extent of vehicle damage in accordance with the presently described embodiments;

FIG. 4B depicts an exemplary computer-implemented method for estimating the extent of vehicle damage before the vehicle is damaged in a crash in accordance with the presently described embodiments;

FIG. 5A depicts an exemplary computer-implemented method for determining the treatment complexity level of the damaged vehicle in accordance with the presently described embodiments;

FIG. 5B depicts an exemplary computer-implemented method for determining the treatment complexity level of the vehicle before the vehicle is damaged in a crash in accordance with the presently described embodiments;

FIG. 6 depicts an exemplary computer-implemented method for determining the treatment facility in accordance with the presently described embodiments;

FIG. 7 depicts an exemplary computer-implemented method for treating the damaged vehicle in accordance with the presently described embodiments;

FIG. 8 depicts another exemplary computer-implemented method for treating the damaged vehicle in accordance with the presently described embodiments;

FIG. 9 is an exemplary block diagram depicting a mobile computing device, an on-board computing device, a server device, and a communication network that may configured in the exemplary system for treating a damaged vehicle in accordance with the described embodiments;

FIG. 10 is a block diagram of an exemplary mobile computing device, on-board computing device, and/or server device capable of being implemented in the system shown in FIG. 9; and

FIGS. 11-14 depict exemplary embodiments of displayed information on the user interface of the computing device(s) in accordance with the presently described embodiments.

### DETAILED DESCRIPTION

A vehicle treatment system utilizes crash information of a vehicle involved in a crash to approximate the extent of damage to the vehicle and determine a treatment facility for treating the damaged vehicle. The estimated vehicle damage may be used to calculate a treatment complexity level for treating the vehicle. Based upon a determined treatment complexity level, the system identifies a treatment facility capable of treating the damaged vehicle and sends information for transporting the damaged vehicle to the treatment facility, thereby removing the need to initially bring the damaged vehicle to an interim location for a damage assessment before transporting the damaged vehicle to a designated treatment facility for treatment.

More specifically, the vehicle treatment system may receive crash information in the form of acceleration, velocity, and/or impact direction of the vehicle at the time of the crash. To estimate the extent of vehicle damage caused in the crash, the system analyzes one or more aspects of the crash information. In one exemplary embodiment, the system calculates an estimate of the vehicle damage by comparing the crash information to collision data of a vehicle type that includes the damaged vehicle. The collision data may include various levels of vehicle damage associated with specified aspects of collision information. For example, one category of vehicle damage in the collision data may be equated to a particular vehicle acceleration or velocity, or a range of vehicle accelerations or velocities. Other categories of vehicle damage in the collision data may also be equated to a vehicle direction, which indicates where the damaged vehicle was likely impacted. Based upon the extent of vehicle damage estimated by the comparison of the crash information to the collision data, the system determines a treatment complexity level for treating the damaged vehicle. Thereafter, information related to treating the damaged vehicle is then transmitted by the system. The treatment information may be automatically sent to a treatment facility, a vehicle transporter, a person or entity such as the vehicle owner, or an associated insurance agent, for example. As such, this system allows for vehicles damaged in a collision to be transported directly to a treatment facility capable of performing the desired treatment (e.g., repair, salvage, cannibalization, scrap); soon after the crash, thereby avoiding the time associated with bringing the damaged vehicle to an assessment center or having an adjuster visit the damaged vehicle to assess an insurance claim before the damaged vehicle is brought to a designated treatment facility.

Further, a vehicle treatment system, including part of, in conjunction with, or separate from the vehicle treatment system described above, utilizes pre-crash information of a vehicle before it is involved in a crash to approximate the extent of damage to the vehicle if and when the vehicle is involved in a crash, and determine a treatment facility for treating the damaged vehicle. The estimated vehicle damage is used to calculate a treatment complexity level for treating the vehicle. Based upon a determined treatment complexity level, the system identifies a treatment facility capable of treating the damaged vehicle and sends information for transporting the damaged vehicle to the treatment facility, thereby removing the need to initially bring the damaged vehicle to an interim location for a damage assessment, storing the vehicle before transporting the damaged vehicle to a designated treatment facility for treatment, and/or treating the damaged vehicle, as well as associated costs such as towing the vehicle to and from the different locations.

More specifically, the vehicle treatment system receives pre-crash information in the form of sensor data from the vehicle, telematics data about the vehicle, the value of the vehicle, the make and model of the vehicle, the year of manufacture of the vehicle, images of the vehicle and past insurance claims/collision data about the vehicle, prior to the vehicle being involved in crash (or at least prior to notice of the vehicle being involved in a crash). To estimate the likelihood of total loss, the system analyzes one or more aspects of the pre-crash information. In one exemplary embodiment, the system calculates an estimate of the vehicle damage and associated cost of treating the damaged vehicle by comparing the pre-crash information to collision data of a vehicle type that includes the vehicle (e.g., similar make, model, year, actual cash value, etc.).

The collision data may include various levels of vehicle damage associated with specified aspects of collision information. For example, one category of vehicle damage in the collision data may be equated to a particular vehicle make, model and year of manufacture. Other categories of vehicle damage in the collision data may also be equated to a cost and time for treating the vehicle, including, but not limited to, appraisal of damage, transportation, storage, repair, rental vehicle, etc. Based upon the vehicle damage estimated by the comparison of the pre-crash information to the collision data of comparable vehicles, the system determines a treatment complexity level for treating the vehicle if and when it is damaged in a crash. For example, it may be estimated that the cost for treating the vehicle will likely be greater than (or otherwise within a certain percentage of) the value of the vehicle, in which case the vehicle is considered prone to total loss, such that the treatment complexity level results in selecting a treatment for scrapping the vehicle, independent of any actual damage to the vehicle. Thereafter, information related to treating the damaged vehicle is then transmitted by the system. If and when the vehicle is damaged in a crash, the treatment information may be sent to a treatment facility, a vehicle transporter, a person or entity such as the vehicle owner, or an associated insurance agent, for example. As such, this system allows for vehicles prone to total loss to be transported directly to a treatment facility for scrapping the vehicle soon after the crash, thereby avoiding the time associated with bringing the damaged vehicle to an assessment center or having an adjuster visit the damaged vehicle to assess an insurance claim, bringing the damaged vehicle to a designated storage facility and/or another treatment facility, transportation costs (e.g., towing) for moving the vehicle, rental costs for a replacement vehicle, etc.

Actual or past auto claim data may be depersonalized or scrubbed of sensitive information. The scrubbed auto claim data may then be used to train a machine language program to identify or predict vehicles that are prone, or predisposed, to being classified as a “total loss” in the event of a vehicle collisions, such as based upon make, model, age, miles, etc. Vehicle characteristic data for a vehicle involved in a vehicle collision may subsequently be input into the trained machine language program to predict whether the vehicle is a total loss, and if so, total loss processing may be expedited without visual human inspection of the vehicle.

### Exemplary Embodiments

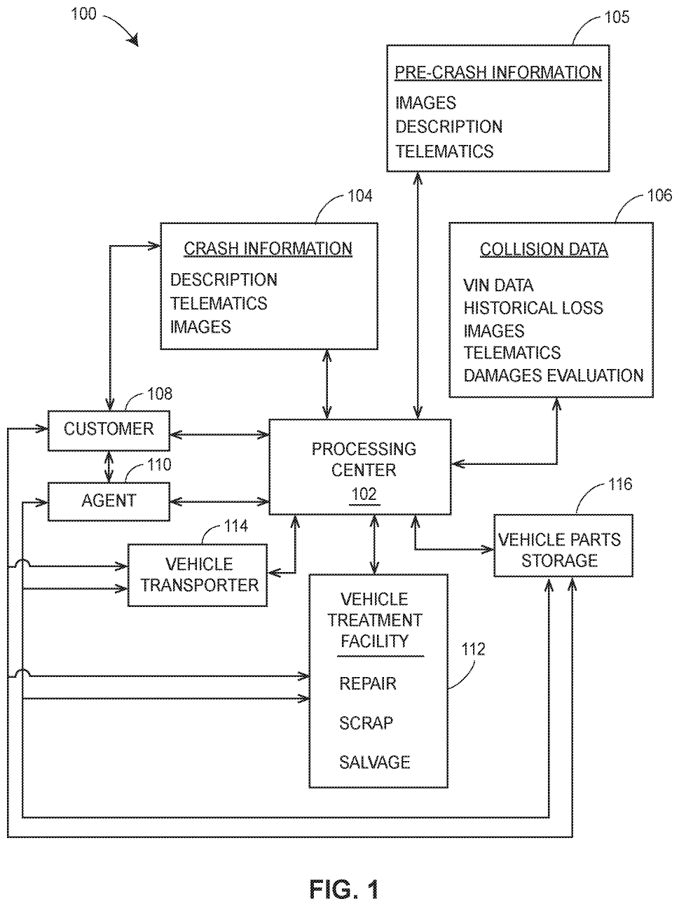

FIG. 1 is a general overview of a system 100 for determining a treatment of a vehicle damaged in a crash, including a determination of a treatment of a vehicle before the vehicle is damaged in a crash. As used herein, the term “vehicle” refers to any type of powered transportation device, which includes, and is not limited to, an automobile, truck, bus, motorcycle, or boat—including self-driving or autonomous vehicles. While the vehicle may normally be controlled by an operator, it is to be understood that the vehicle may be unmanned and remotely or autonomously operated in another fashion, such as using controls other than the steering wheel, gear shift, brake pedal, and accelerator pedal.

The system 100 in FIG. 1 includes a processing center 102 capable of facilitating an analysis of the damaged vehicle's crash information 104 and the vehicle's pre-crash information 105. The analysis may include a comparison of the damaged vehicle's crash information 104 and/or pre-crash information 105 with collision data 106 to estimate the extent of vehicle damage and determine a treatment for the vehicle. Throughout this description, the term crash is used in reference to the particular incident in which the vehicle was damaged and the term collision is used in reference to one or more incidents in which another vehicle or vehicles were damaged. The analysis of the crash information 104 and pre-crash information may be performed by system personnel and/or a computing device at the processing center 102.

As used herein, the term “crash” refers to any incident involving the vehicle that results in damage to the vehicle, which includes, and is not limited to, a collision with another object, a weather event or vandalism. The crash information 104 provided to the processing center 102 includes specific information related to the crash that damaged the vehicle and may include information received from the vehicle owner 108, driver, or occupant, an insurance agent 110 and/or entity of the damaged vehicle, an emergency responder, an accident investigator. The crash information 104 may include impact characteristics of the vehicle involved in the crash, which may be provided to system personnel and/or the processing center 102 by an observer of the damaged vehicle. For example, the driver of the damaged vehicle may provide crash information such as the approximate speed of the vehicle at the time of the crash and what area of the vehicle was damaged. Other observed crash information provided to system personnel and/or the processing center 102 may include whether the vehicle's airbags deployed or if the vehicle is drivable. In addition, images of the damaged vehicle may be for comparison to images of vehicles of the same or similar type with known damage from other collisions. Some impact characteristics of the crash may be automatically relayed to system personnel and/or the processing center 102 by telematics devices (e.g., sensors), operatively coupled to the vehicle. The sensors enable a computing device to automatically attain impact characteristics such as vehicle acceleration, velocity, and/or direction at the time of the crash, and GPS location of the vehicle and/or collision.

Additional crash information may include the damaged vehicle's identification number (VIN) and related data, which may have been made available to system personnel and/or the processing center 102 prior to the crash. The VIN data may include the make, model, year, and type of vehicle as well as previous damage/repair information and insurance claim information associated with the damaged vehicle.

The pre-crash information 105 provided to the processing center 102 includes specific information about the vehicle before a crash occurs, and may include information received from the vehicle owner 108, driver, or occupant, an insurance agent 110 and/or entity of the vehicle. The pre-crash information 105 may include the VIN data described above, and images of the vehicle, such as may be taken at the time of renewing an insurance policy for the vehicle. The pre-crash information 105 may also include sensor data from telematics devices or sensors operatively coupled to the vehicle, such as velocity, acceleration, location, direction, driving habits, etc.

Other types of pre-crash information 105 may include additional vehicle information, such as estimated or actual height or weight, estimated or actual age, estimated actual value, estimated replacement cost, estimated vehicle value or worth, estimated or actual miles, estimated or actual age of various components (engine, drive train, transmission, tires, etc.), estimated or actual wear on tires or vehicle components, etc.

Additionally or alternatively, the pre-crash information 105 (as well as the collision data 106 mentioned below) may include historical auto claim data and a determination of which types of vehicles may be more prone to being classified as a “total loss” in the event of a vehicle collision. For instance, by analyzing the historical auto claim data, such as via a machine learning or other algorithm, it may be determined which vehicle classifications (e.g., make, model, vehicle type (motorcycle, compact, large auto, truck, or SUV for instance, age, estimated or actual value, miles, height, weight, frame size or type, frame materials, etc.), lend themselves to total loss characterization after a vehicle collision.

In addition or alternatively to above, collision data 106 may generally include records or compilations of information involving other vehicles damaged in other collisions, such as VIN data, historical loss information, images, telematics information, and vehicle damage evaluation. The collision data 106 may be periodically updated and any of the collision data utilized by system personnel and/or the processing center 102 may be stored in the system 100 and/or operatively coupled to the processing center.

The VIN data may include vehicle manufacturer information such as recommended repair procedures and costs, vehicle part warranties, costs and market value estimations of various vehicles and vehicle parts, etc. The VIN database may also include vehicle safety information including, and not limited to, vehicle part recall information, safety notices, repair notices, etc. Historical loss information may include observed or measured amounts of vehicle damage associated with or resulting from known, observed, or measured aspects relating to a collision or impact of another vehicle, such as vehicle acceleration, velocity, and/or direction. Some examples of historical loss data include vehicle crash test results, bumper test results, traffic accident investigations, and the like. Various impact characteristics such as vehicle acceleration, velocity, direction, and/or image may be compiled into a chart or table and associated with known vehicle damage.

A damage evaluation tool may include a guide or template to be used in estimating the extent of vehicle damage. For example, stored images and operating characteristics of vehicles damaged in other collisions may be used to compare with like images and operating characteristics of the vehicle damaged in the crash.

Treatment for the damaged vehicle can be facilitated by comparing the crash information with the collision data. That is, the extent of vehicle damage resulting from the crash can be estimated by comparing impact aspects of the crash with similar impact aspects of similar vehicles involved in past collisions. The compilation of impact characteristics associated with known vehicle damage from similar vehicles involved in previous collisions may be used as a guide or template to estimate the amount of damage that occurred to the vehicle involved in the crash.

Once the extent of vehicle damage has been estimated, an estimate for treating the vehicle can be determined. In short, various levels of vehicle damage may be equated with various levels of vehicle treatment. That is, the estimated extent of vehicle damage may be equated to a treatment complexity level. For example, minor, medium, and major vehicle damage may be equated to minor, medium and major vehicle repair. Irreparable vehicle damage may be equated to a scrapping or salvaging treatment. Once the vehicle treatment complexity has been estimated, system personnel and/or the processing center 102 may identify a vehicle treatment facility 112 capable of performing the requisite treatment. A vehicle transporter 114 may be contacted by system personnel and/or the processing center 102 to transport the damaged vehicle from the crash site to the identified treatment facility 112 (e.g., a service repair center, a scrapping or salvaging facility). For irreparable vehicles, the damaged vehicle may be dismantled before scrapping and undamaged vehicle parts may be salvaged and stored at a warehouse 116 for reuse and resale.

In addition, or in the alternative, determination of treatment for the vehicle can be facilitated, at least in part, even before the vehicle is damaged in a crash by comparing the pre-crash information with collision data. That is, whether or not a vehicle is considered a total loss (i.e., for salvaging parts or scrap) as a result of a crash can be estimated or determined by comparing the likely cost of treating the vehicle for repair with the value of the vehicle based upon aspects of similar vehicles involved in past collisions. For example, the cost for even a minor or medium repair (e.g., fixing or replacing a bumper on the vehicle) may amount to a significant percentage of the vehicle's actual cash value, either because of the likely cost involved with treating the vehicle (e.g., due to high repair costs, availability of parts, location, complexity of repairs, etc.) and/or the vehicle's value (e.g., due to make, model, age, etc.). Again, the compilation of impact characteristics associated with known vehicle damage from similar vehicles involved in previous collisions may be used as a guide or template to estimate the likely amount of damage to the vehicle if it is involved in a crash.

Once the likely extent of vehicle damage has been estimated, a determination as to whether the vehicle is a total loss or not may be performed. In short, various levels of vehicle damage may be equated with a total loss of the vehicle. That is, the estimated likely extent of vehicle damage may be equated to a treatment complexity level for scrapping or salvaging the vehicle. For example, even minor, medium, or major vehicle damage may be equated to a total loss of the vehicle depending on the cost of treating the vehicle for repair, thus subjecting the vehicle to a scrapping or salvaging treatment.

Once the vehicle treatment complexity has been estimated, system personnel and/or the processing center 102 may identify whether the vehicle is prone to total loss. When the vehicle is damaged in a crash or notification is provided that the vehicle was involved in a crash, a vehicle transporter 114 may be contacted by system personnel and/or the processing center 102 to transport the damaged vehicle from the crash site to the identified treatment facility 112, which, if the vehicle is prone to total loss, would be a scrapping or salvaging facility. The damaged vehicle may be dismantled before scrapping and undamaged vehicle parts may be salvaged and stored at a warehouse 116 for reuse and resale.

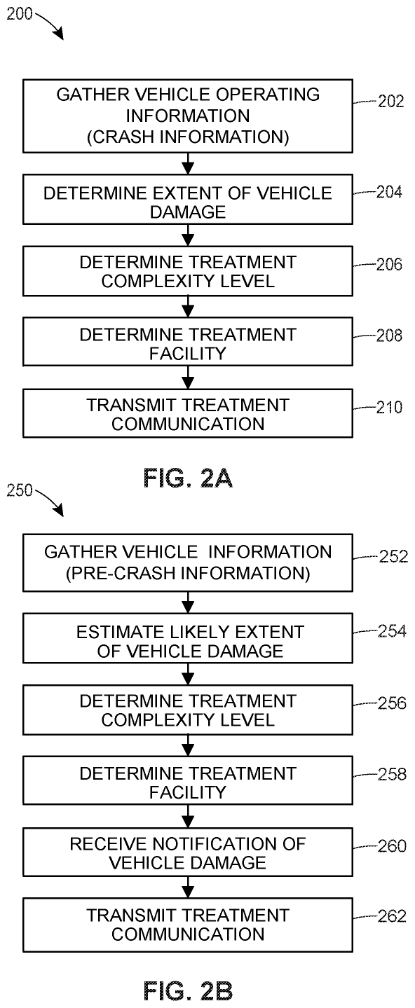

FIG. 2A is a flow diagram 200 depicting an exemplary embodiment of a vehicle treatment process that may be implemented by the treatment system 100 shown in FIG. 1. More particularly, the method 200 may be executed separately or cooperatively by system personnel and the processing center 102. Vehicle crash information may be gathered for analysis (block 202). The vehicle crash information may be provided to system personnel and/or the processing center 102 by a vehicle occupant or emergency responder communicating characteristics of the crash. The crash characteristics may include descriptions of the approximate speed the vehicle was moving at the time of the crash, where the vehicle was damaged, the type of damage to the vehicle, whether the vehicle may be operated and/or moved, if the vehicle's airbags or other safety systems were deployed as a result of the crash, etc.

Crash characteristics may also be provided to system personnel and/or the processing center 102 by the vehicle's engine control unit (ECU) and/or one or more telematics devices that are capable of monitoring and/or noting various vehicle functions (e.g., acceleration, velocity, and/or direction of the vehicle at the time of the crash), sometimes referred to as event data recording (EDR). The telematics devices are operatively coupled to the vehicle and may be configured to automatically function when the vehicle is in operation. For example, the vehicle's operating information (e.g., acceleration, velocity, and/or direction of the vehicle), may be periodically monitored when the vehicle is moving. When a crash occurs, the monitored speed and direction of the vehicle may be automatically attained and transmitted to system personnel and/or the processing center 102 as crash characteristics.

When the crash information is received by system personnel and/or the processing center 102, the crash information is analyzed to determine an estimate of the extent of damage caused to the vehicle during the crash (block 204). The analysis may include calculating the extent of damage by comparing the crash information 104 to collision data 106. Based upon the estimated vehicle damage, a treatment complexity level is determined (block 206). The treatment complexity level may be an estimate indicating the level of difficulty involved with treating the damaged vehicle. The treatment of the vehicle may include repairing or replacing damaged vehicle parts, and in some instances where repairing the vehicle is too costly, scrapping the vehicle. Once the estimated treatment complexity level is determined, one or more treatment facilities capable of performing the requisite treatment may be identified by system personnel and/or the processing center (block 208). System personnel and/or the processing center 102 may then transmit a communication related to the treatment of the damaged vehicle (block 210). For example, system personnel and/or the processing center 102 may contact one or more identified treatment facilities to initiate or inquire further in regard to the continued treatment of the damaged vehicle (block 210).

FIG. 2B is a flow diagram 250 depicting a further example embodiment of a vehicle treatment process that may be implemented by the treatment system 100 shown in FIG. 1. More particularly, the method 250 may be executed separately or cooperatively by system personnel and the processing center 102. Vehicle pre-crash information is gathered for analysis before the vehicle is damaged in a crash (block 252). The vehicle pre-crash information may be provided to system personnel and/or the processing center 102 by the vehicle owner, driver, occupant, an insurance agent and/or entity of the vehicle. The vehicle characteristics may include the VIN data described above (e.g., make, model, year of manufacture, etc.), images of the vehicle, location, etc.

Pre-crash characteristics (e.g., driving patterns, characteristics, habits, etc.) may also be provided to system personnel and/or the processing center 102 by the vehicle's engine control unit (ECU) and/or one or more telematics/sensor devices that are capable of monitoring and/or noting various vehicle functions (e.g., acceleration, velocity, and/or direction of the vehicle), which may be used to determine the driving behavior of the primary driver(s) of the vehicle. The telematics devices may be operatively coupled to the vehicle (or may include an Application running on a driver's mobile device) and may be configured to automatically function when the vehicle is in operation. For example, the vehicle's operating information (e.g., acceleration, velocity, and/or direction of the vehicle), may be periodically monitored when the vehicle is moving. The monitored speed and direction of the vehicle may be regularly and automatically attained and transmitted to system personnel and/or the processing center 102 as pre-crash driving characteristics, or automatically attained and transmitted during a “test period” before, at the beginning of, or around renewal of a vehicle insurance policy.

When the pre-crash information is received by system personnel and/or the processing center 102, the pre-crash information may be analyzed to determine an estimate of the likely extent of damage to the vehicle during a crash (block 254). The analysis may include calculating the likely extent of damage by comparing the pre-crash information 105 to collision data 106. For example, a comparison of the pre-crash information 105 to collision data 106 may indicate that for similar vehicles, the vehicle is likely to sustain a certain type of damage or extent of damage, particularly if the driving habits are known. The comparison may indicate that a significant percentage of crashes with similar cars for which insurance claims were made results in damage to the front or rear bumpers and/or some body repair.

Based upon the estimated likely extent of vehicle damage, a treatment complexity level is determined (block 256) before the vehicle is damaged in a crash. The treatment complexity level may be an estimate indicating the likely level of difficulty and/or expense involved with treating the vehicle. The treatment of the vehicle may include repairing or replacing damaged vehicle parts, but even where the repair or replacement might otherwise be considered minor or medium, the cost of the repair and/or replacement may be too costly, such that it is more cost-effective to scrap the vehicle. That is, the estimated extent of vehicle damage and the associated cost of treatment may be equated to a treatment complexity level. For example, minor, medium, and major vehicle damage may be equated to minor, medium and major vehicle repair. In addition, the determination of the treatment complexity level may take into account the cost for repairing or replacing the damaged part(s) using a price schedule. The price schedule may vary depending upon the costs of various treatment facilities, storage facilities, parts, vehicle transporters, etc. Using the price schedule and the estimated likely extent of damage to the vehicle, the vehicle treatment process may estimate the likely cost of repairing the vehicle if and when it is damaged in a crash.

Further, the estimated likely cost of repairing the vehicle may be compared to the value of the vehicle, as obtained or determined from the pre-crash vehicle information (e.g., by comparing the make, model and year of manufacture of the vehicle to a schedule of actual cash values for the same make and model of vehicle varying by year). Using a predetermined percentage (or range of percentages) of the value of the vehicle as a threshold, if the cost of repairing the vehicle is likely to meet or exceed the predetermined percentage of the value of the vehicle, the treatment complexity level may be equated to scrapping or salvaging the vehicle. That is, the vehicle is considered prone to being a total loss before the vehicle is damaged in a crash.

As an example, it may be determined that a vehicle is 90% likely to having repair costs of $2400 or more if it is damaged in a crash (e.g., likely to require body work and a new bumper or other treatment). The value of the vehicle is anywhere between $3200 and $3600 as compared to similar vehicles. Where the predetermined percentage of the value of the vehicle is set at 75%, it may be determine that the cost for repairing the vehicle is likely to be 75% or more of the value of the vehicle, such that the vehicle is prone to being classified as a total loss. As such, the treatment complexity level for the vehicle is equated to scrapping or salvaging the vehicle even before the vehicle is damaged in a crash, regardless of actual damage to the vehicle if and when it is damaged in a crash. Thus, using the price schedule in conjunction with the estimated likely extent of damage, the treatment complexity level associated with treating the vehicle after a crash may be determined even before the vehicle is damaged in a crash using the price schedule for treating the damaged vehicle and the value of the vehicle.

Once the estimated treatment complexity level is determined before the vehicle is damaged in a crash, one or more treatment facilities capable of performing the requisite treatment may be identified by system personnel and/or the processing center (block 258). A treatment facility may be identified before the vehicle is damaged in a crash or upon notification that the vehicle has been damaged in a crash. In particular, the treatment facility may be one for scrapping or salvaging the vehicle, regardless of the actual damage sustained by the vehicle. In this particular example, the treatment facility may be identified before receiving notice that the vehicle has been damaged in a crash (block 260). Notification may be sent from, for example, the owner of the vehicle or insurance policy holder for the vehicle, and received by system personnel and/or the processing center in the form of an SMS text, e-mail, phone call, facsimile, website submission, etc.

Upon receiving notification, if the vehicle is determined to be prone to total loss, the owner/policy holder may be automatically offered an insurance settlement (payout), thereby obviating any further need to assess the damage to the vehicle, much less transport, store or repair the vehicle except for what may be necessary to scrap or salvage the vehicle. In one example, the insurance settlement may be for a value of the vehicle, such as the actual cash value or a percentage thereof. System personnel and/or the processing center 102 may then transmit a communication related to the treatment of the damaged vehicle (block 262). For example, system personnel and/or the processing center 102 may contact one or more identified treatment facilities to initiate or inquire further in regard to the scrapping or salvage of the damaged vehicle (block 262).

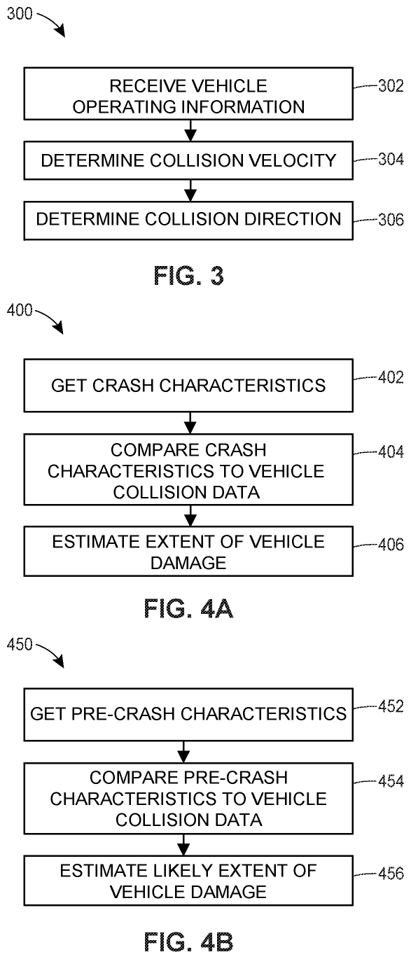

A flow diagram 300 of an exemplary embodiment for gathering vehicle crash information is depicted in FIG. 3. Crash information may be received by system personnel and/or the processing center 102 from an individual(s) present at the crash site, such as a vehicle occupant or an emergency responder (block 302). For example, the driver of the vehicle may contact system personnel and/or the processing center 102 and provide the approximate speed the vehicle was moving at the time of the crash (block 304), where the vehicle was damaged (block 306), descriptions and/or images of the damaged vehicle, whether the vehicle can be started and/or driven, if the vehicle's airbags or other safety systems were deployed as a result of the crash, etc. In addition, similar and/or additional crash information may be provided by the vehicle's EDR as well.

In treatment systems 100 where telematics devices are utilized, similar crash information may be automatically provided to system personnel and/or the processing center 102 by a computing device and/or telematics devices operatively coupled to the vehicle. In particular, while the vehicle is being operated, the vehicle's operating information may be monitored by a series of measurements of operating conditions or characteristics pertaining to the operation of the vehicle. For example, one or more computing devices such as a mobile computing device, an on-board computing device, and/or a server device may be communicatively coupled to sensors such as an accelerometer array operatively coupled to the vehicle. The accelerometer array may monitor and/or measure the acceleration of the vehicle along several axes and/or travelling directions. Measured operating information such as vehicle acceleration, velocity, and direction may be logged periodically (e.g., every millisecond, every second, etc.) or conditionally on the occurrence or detection of an event (e.g., a crash) and stored in the system 100, for example, as an event log (e.g., crash log) in a data storage unit of the system or a remote storage unit communicatively coupled to the system. The crash log may include a timestamp to note the time of the measurement.

In one exemplary configuration, system personnel and/or the processing center 102 may determine, derive, or deduce additional crash information. In particular, the vehicle acceleration at the time of the crash may be considered primary crash information, wherein additional, or secondary, crash information may include a crash velocity and/or a crash direction, which may be mathematically derived by system personnel and/or the processing center 102 from the acceleration monitored and/or measured via the accelerometer and computing device.

More particularly, the system's 100 computing device(s) may monitor, via the accelerometer array, acceleration associated with the vehicle in the X, Y, and/or Z axes and create accelerometer logs. In some embodiments, the X-axis may be oriented along a front-back axis aligned with the vehicle and/or mobile and/or on-board computing device, the Y-axis may be oriented along a side-side axis aligned with the vehicle and/or mobile or on-board computing device, and the Z-axis may be oriented along a top-bottom axis aligned with the vehicle and/or mobile and/or on-board computing device. However, these axes may be positioned in other ways.

Detection of a vehicle crash may be facilitated by the use of the accelerometer. For example, a crash may be detected when a computing device operatively coupled to the accelerometer notes a significant, near immediate increase or decrease in the monitored acceleration in the fore-aft, lateral, and/or vertical direction of the vehicle (e.g., X, Y, and Z axes). Alternatively, a crash may be detected by a GPS unit via detection of a significant increase or decrease in vehicle velocity, or through near-simultaneous activation of an emergency response such as the deployment of an air-bag or an alert (e.g., automatic collision notification (ACN), etc.).

A flow diagram 400 of an exemplary embodiment for estimating the extent of vehicle damage is depicted in FIG. 4A. Some or all of the method for estimating the extent of vehicle damage may be implemented by system personnel and/or the processing center 102. In particular, system personnel may utilize crash characteristics provided by an individual present at the crash site, such as the driver and/or occupant of the damaged vehicle or an emergency responder (block 402). For example, descriptions and images of the damaged vehicle and an approximate speed of the vehicle at the time of the crash and the direction of where the vehicle was damaged may be provided to system personnel by the driver of the vehicle. Alternatively, system personnel and/or the processing center 102 may utilize crash characteristics automatically attained by telematics devices operatively coupled to the vehicle. Some examples of crash characteristics include, and are not limited to, vehicle acceleration, velocity, and/or direction. Some crash information may be attained by an accelerometer and an array of sensors at the time of the crash and the transmitted via a wireless communication module to system personnel and/or the processing center 102. System personnel and/or the processing center 102 may then analyze the crash information.

In one exemplary embodiment, system personnel and/or the processing center 102 may compare various combinations crash characteristics to collision data (block 404). The collision data may include historical loss information of similar type vehicles damaged in past collisions. The collision data may be compiled from past collisions and/or from laboratory crash test results s involving other vehicles of the same or similar type as the damaged vehicle. The collision data may further include one or several combinations of impact or collision characteristics that are equated and/or associated to a known amount of vehicle damage. For example, vehicle damage associated with front-end impacts at various vehicle speeds may be associated with a list of vehicle parts likely to need repair and/or replacement from such impacts. By comparing the crash characteristics of the damaged vehicle to impact and/or collision characteristics of the collision data, an extent of damage to the damaged vehicle may be estimated (block 406).

A flow diagram 450 of an exemplary embodiment for estimating the extent of vehicle damage before the vehicle is damaged in a crash is depicted in FIG. 4B. Some or all of the method for estimating the extent of vehicle damage may be implemented by system personnel and/or the processing center 102. It should be understood that estimating the extent of vehicle damage before the vehicle is damaged in a crash may obviate any need to estimate the extent of vehicle damage after the vehicle is damaged in a crash, such that the embodiment for estimating the extent of vehicle damage depicted in FIG. 4A is unnecessary, particularly if the vehicle is determined to be prone to total loss. That is, the vehicle treatment process treats the damaged vehicle as a total loss for salvaging or scrapping, regardless of the actual damage to the vehicle.

Referring to FIG. 4B, system personnel may utilize pre-crash characteristics provided by the vehicle owner, driver, occupant, an insurance agent and/or entity of the vehicle (block 452). For example, the VIN data described above (e.g., make, model, year of manufacture, etc.), descriptions and images of the vehicle, etc. may be provided to system personnel by the driver of the vehicle. Alternatively, or in addition, system personnel and/or the processing center 102 may utilize pre-crash characteristics automatically attained by telematics devices operatively coupled to the vehicle, such as driving characteristics. Some examples of driving characteristics include, and are not limited to, vehicle acceleration, velocity, and/or direction. Some driving characteristics may be attained by an accelerometer and an array of sensors, and transmitted via a wireless communication module to system personnel and/or the processing center 102.

System personnel and/or the processing center 102 may then analyze the driving characteristics to determine driving patterns, driver behavior, and other factors indicative of how the vehicle is driven (e.g., chronic speeding, hard stops, etc.) that may contribute to the extent of damage if and when the vehicle is involved in a crash. In one exemplary embodiment, system personnel and/or the processing center 102 may compare various combinations pre-crash characteristics to collision data (block 454).

As above, the collision data may include historical loss information of similar type vehicles damaged in past collisions, including the most common types of damage. The collision data may be compiled from past collisions and/or from laboratory crash test results involving other vehicles of the same or similar type as the vehicle. The collision data may further include one or several combinations of impact or collision characteristics that are equated and/or associated to a known amount of vehicle damage. For example, vehicle damage associated with front-end impacts at various vehicle speeds may be associated with a list of vehicle parts likely to need repair and/or replacement from such impacts. By comparing the crash characteristics of the damaged vehicle to impact and/or collision characteristics of the collision data, a likely extent of damage to the damaged vehicle may be estimated before the vehicle is damage in a crash (block 456). For example, the collision data for similar vehicles may indicate that most crashes result in at least damage to the body work of the vehicle, at a minimum.

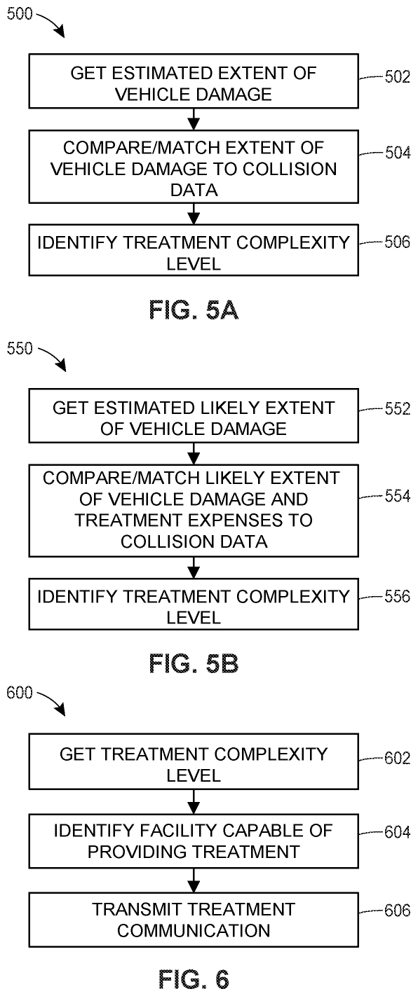

FIG. 5A depicts a flow diagram 500 of an exemplary embodiment for estimating the treatment complexity level, which may be accomplished by system personnel and/or the processing center 102. The collision data may include a range of treatment complexity levels associated with various amounts of vehicle damage. In general, a treatment complexity level represents the difficulty associated with treating the damaged vehicle and may include or be associated with a pricing schema having a predetermined price structure for treating the damaged vehicle. A range of vehicle treatment complexity levels may be delineated by the amount of involvement associated with repairing and/or replacing vehicle parts of the damaged vehicle, or to scrap the damaged vehicle. Each treatment complexity level may include estimates or indications of the repair time and cost associated with the type and amount of vehicle body parts that may be damaged (e.g., body panel (front, side, rear, quarter-panel, rocker, driver-side, and passenger-side), bumper, radiator, lights, water pump, battery, struts, frame, and gas tank). The several levels of treatment complexity may include a speed or light repair, a medium or moderate repair, a heavy or severe repair, not repairable, scrap, and salvage, for example.

A speed or light repair treatment designation may indicate or estimate that one or two vehicle parts need repair or replacement, or that minor refinishing may be required, but that no structural damage occurred to the vehicle. A medium or moderate repair treatment designation may indicate that a few vehicle parts require repair or replacement or that light structural damage occurred to the vehicle. A heavy or extensive repair treatment designation may indicate that the vehicle is not drivable, significant structural damage occurred to the vehicle, more than five vehicle parts need repair or replacement, or a welded-on vehicle component needs replacement. A scrap designation may indicate that the vehicle is to be scrapped not repaired. Prior to scrapping, the damaged vehicle may be dismantled to salvage any undamaged or usable vehicle parts.

The estimated extent of vehicle damage attained by system personnel and/or the processing center 102 may include a list of vehicle parts estimated to be damaged (block 502). By comparing and matching the damaged list of vehicle parts to the vehicle collision data (block 504), system personnel and/or the processing center 102 may identify the requisite treatment complexity level (block 506). For example, a vehicle damage estimate requiring less than 10 hours of repair time or $1000 in vehicle parts and labor may be designated as a low treatment complexity level; a vehicle damage estimate requiring between 10-15 hours of repair time or between $1000-$2500 in vehicle parts and labor may be designated as a medium treatment complexity level; a vehicle damage estimate requiring between 15-30 hours of repair time or between $2500-$5000 in vehicle parts and labor may be designated as a high treatment complexity level; and a vehicle damage estimate requiring more than 30 hours of repair time, or having costs in vehicle parts and labor greater than the value of the damaged vehicle in an undamaged condition, may be designated as a scrapping treatment complexity level.

FIG. 5B depicts a flow diagram 550 of an exemplary embodiment for estimating the treatment complexity level of the vehicle before the vehicle is damaged in a crash, which may be accomplished by system personnel and/or the processing center 102. In general, a treatment complexity level in this exemplary embodiment represents the cost effectiveness associated with treating the damaged vehicle, and may include or be associated with the value of the vehicle and a pricing schema having a predetermined price structure for treating the damaged vehicle. A range of vehicle treatment complexity levels may be delineated by the amount of involvement and cost associated with repairing and/or replacing vehicle parts of the damaged vehicle, or to scrap the damaged vehicle, depending on how that involvement/cost compares to the value of the vehicle.

Each treatment complexity level may include estimates or indications of the repair time and cost associated with the type and amount of vehicle body parts that are likely to be damaged if and when the vehicle is damaged in a crash (e.g., body panel (front, side, rear, quarter-panel, rocker, driver-side, and passenger-side), bumper, radiator, lights, water pump, battery, struts, frame, and gas tank). Each treatment complexity level may further include estimates or indications of other associated time and costs, such as transportation of the damaged vehicle, storage of the damaged vehicle, rental for a replacement vehicle while the damage vehicle is being repaired, etc. As above, the several levels of treatment complexity may include a speed or light repair, a medium or moderate repair, a heavy or severe repair, not repairable, scrap, and salvage, for example.

A speed or light repair treatment designation may indicate or estimate that one or two vehicle parts need repair or replacement, or that minor refinishing may be required, but that no structural damage occurred to the vehicle. A medium or moderate repair treatment designation may indicate that a few vehicle parts require repair or replacement or that light structural damage occurred to the vehicle. A heavy or extensive repair treatment designation may indicate that the vehicle is not drivable, significant structural damage occurred to the vehicle, more than five vehicle parts need repair or replacement, or a welded-on vehicle component needs replacement. A scrap designation may indicate that the vehicle is irreparable.

Prior to scrapping, the damaged vehicle may be dismantled to salvage any undamaged or usable vehicle parts. However, one or more of the above treatment designations may be equivalent to considering the vehicle a total loss, thereby becoming a scrap designation, if the cost of the treatment designation meets or exceeds a predetermined percentage of the vehicle's value.

The estimated likely extent of vehicle damage attained by system personnel and/or the processing center 102 may include a list of vehicle parts estimated to be likely damaged in a crash (block 552). By comparing and matching the estimated likely extent of damage (e.g., an estimated likely list of damaged vehicle parts) as well as other accompanying expenses (e.g., storage, vehicle transportation, etc.) to the vehicle collision data (block 554), system personnel and/or the processing center 102 may identify the requisite treatment complexity level (block 556).

For example, a vehicle damage estimate requiring less than 10 hours of repair time or $1000 in vehicle parts and labor may be designated as a low treatment complexity level; a vehicle damage estimate requiring between 10-15 hours of repair time or between $1000-$2500 in vehicle parts and labor may be designated as a medium treatment complexity level; a vehicle damage estimate requiring between 15-30 hours of repair time or between $2500-$5000 in vehicle parts and labor may be designated as a high treatment complexity level; and a vehicle damage estimate requiring more than 30 hours of repair time, or having costs in vehicle parts and labor greater than a predetermined percentage of the value of the damaged vehicle in an undamaged condition (or at least as valued without the damage requiring treatment), may be designated as a scrapping treatment complexity level. In the latter case, if the value of the vehicle is $3200 and a predetermined percentage of the vehicle by which the vehicle is deemed prone to total loss is 75%, then even a medium treatment complexity level may meet or exceed the threshold percentage of the vehicle's value, such that the treatment complexity level is considered a scrapping treatment complexity level.

FIG. 6 depicts a flow diagram 600 of an exemplary computer-implemented method for identifying the treatment facility for treating the damaged vehicle. Once the treatment complexity level is estimated as depicted in either FIG. 5A or FIG. 5B, system personnel and/or the processing center 102 may begin to determine an appropriate treatment facility for the damaged vehicle. In the case of FIG. 5B, where estimating the treatment complexity level is performed before the vehicle is damaged in a crash, determining an appropriate treatment facility may likewise be performed before the vehicle is damaged in a crash, or after the vehicle is damaged in a crash.

The treatment complexity level is attained (block 602) and may be compared by system personnel and/or the processing center 102 to a list of treatment facilities that may be capable of providing the necessary treatment (block 604). Matching the estimated treatment complexity level with the treatment facilities in the list may be based upon one or more factors, such as a pricing structure, treatment facility capability, treatment facility location, treatment facility quality rating and/or certification, treatment facility availability, time, etc. and combinations thereof. One or more of these factors may also be weighted and/or prioritized by system personnel and/or the processing center 102 when determining a treatment facility for treatment of the vehicle. For example, a low complexity treatment generally does not require a high skill level and the convenience of a treatment facility near the vehicle owner may be considered to be more beneficial.

Thus, for a low complexity treatment, the location factor of the treatment facility may be weighted and/or prioritized over some of the other factors. For medium or high complexity treatments, the skill level and/or performance record of the treatment facility may be considered to be more important and thus weighted and/or prioritized over some of the other factors.

When a treatment facility is identified, a communication relating to the treatment of the damaged vehicle may be sent by system personnel and/or the processing center 102 (block 606). For example, the processing center 102 may transmit information associated with the treatment in the form of an SMS text, e-mail, phone call, facsimile, etc. to the identified treatment facility. The information may also be provided to the vehicle owner and/or other entities authorized by the vehicle owner, such as a collision repair facility, a vehicle scrap facility, emergency personnel, an insurance agent, etc. In addition, the information transmitted by the processing center 102 may include a request to the treatment facility or a vehicle transporter to transport the damaged vehicle to the identified treatment facility.

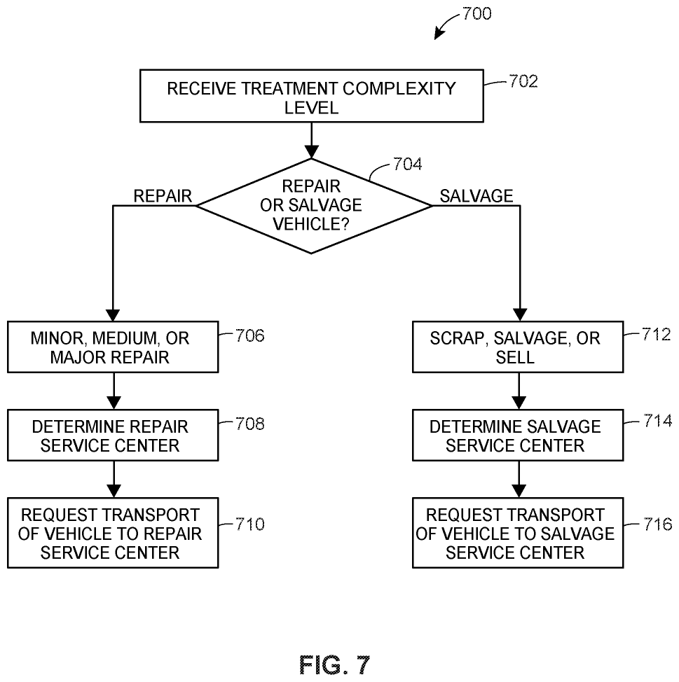

Another exemplary computer-implemented method for identifying the treatment facility for treating the damaged vehicle is depicted in the flow diagram 700 shown in FIG. 7. System personnel and/or the processing center 102 receive the treatment complexity level (block 702), which may then be compared to vehicle collision data. The vehicle collision data may comprise empirical data including measurements of damaged vehicles of the same or similar type to that of the vehicle damaged in the crash. Based upon the comparison, a determination of the type of treatment for the damaged vehicle may be made, generally, to repair the vehicle or salvage the vehicle (block 704).

The determination of the type of treatment may be made by system personnel and/or the processing center 102 comparing one or more characteristics of the damaged vehicle's crash information to a hierarchy of vehicle collision data of similar type vehicles. If the damaged vehicle is to be repaired, an extent of the repairs may be determined (block 706). The range of repair levels may vary from minor to medium to major and the range may be segmented in relation to the treatment complexity levels. In other words, one range of vehicle damages may be associated to one particular treatment complexity level.

The time and cost to repair the damaged vehicle may also be considered in the analysis to determine whether to repair or salvage the damaged vehicle. Additional factors that may also be considered in determining the treatment complexity level include the make, model, and year of the damaged vehicle, and the availability and/or market desirability for undamaged vehicle parts. For example, an older model vehicle may be more expensive to repair because replacement vehicle parts may be difficult to obtain. Once the repair level has been determined, a repair treatment facility may be selected (block 708). At a minimum, the selected repair treatment facility is capable of performing the level of repair necessary. Additional factors that may be considered when determining a repair treatment facility may include the proximity of the repair treatment facility to the damaged vehicle (e.g., collision site); the treatment facility's availability to timely repair the vehicle; and, a current or prior business relationship between the repair treatment facility and the entity using and/or administrating the treatment system 100.

When the repair center is determined, information associated with the repair of the vehicle may be transmitted from system personnel and/or the processing center 102. Such information may include a request to transport the damaged vehicle from the crash site directly to the repair treatment facility (block 710). The request to transport the vehicle may be sent to the selected repair treatment facility or to a vehicle transporter 114 capable of transporting damaged vehicles from collision sites.

If the damage to the vehicle is too extensive or costly to be repaired, the damaged vehicle may be salvaged. In some instances where the damaged vehicle is determined to be a total loss, the vehicle may be immediately sold or put up for auction or scrapped and shredded for its scrap metal (block 712). Scrapping the vehicle may be appropriated for low dollar, high curb weight vehicles where the value of the damaged vehicle is perceived to be in the scrap metal. In other instances, the damaged vehicle may be dismantled to salvage any value associated with the damaged vehicle. For example, if the damaged vehicle includes undamaged vehicle parts, the vehicle may be dismantled and the undamaged vehicle parts may be harvested and stored in a storage facility 116 for later use and/or sale.

The determination to sell or dismantle the damaged vehicle may include consideration of the treatment complexity level, the make, model, and year of the vehicle, and the market demand and/or desirability of particular harvested vehicle parts (e.g., at-risk vehicle parts for vehicles that are no longer in production). Additionally, a higher monetized recovery of the damaged vehicle may be attained if the damaged vehicle is partially repaired and/or dismantled to a varying extent, and then sold. For example, higher end and late model vehicles and/or vehicle parts may be prepared for sale. Such vehicles and vehicle parts, as well as rare or hard to find vehicles and vehicle parts may be privately or publicly sold or auctioned through a salvage treatment facility partnering with an entity using or administrating the treatment system 100. Any unwanted vehicle parts that remain after dismantling may be shredded or scrapped.

Once the salvage level has been determined, a salvage treatment facility may be identified from among the salvage treatment centers (block 714). At a minimum, the selected salvage treatment facility is capable of performing the level of salvage necessary. Additional factors may also be considered to determine a particular salvage treatment facility. For example, the proximity of the salvage treatment facility to the damaged vehicle (e.g., crash site). Further considerations for determining a salvage treatment facility may also include the availability to timely salvage the vehicle, the existence of a current or prior business relationship between the salvage treatment facility and the entity using or administrating the treatment system 100, etc. When the salvage treatment facility is determined, information associated with the salvage of the vehicle may be transmitted by system personnel and/or the processing center 102. Such information may include a request to transport the vehicle to the identified salvage treatment facility (block 716). The request to transport the vehicle may be sent to the selected salvage treatment facility 112 or to a vehicle transporter 114 capable of transporting the damaged vehicle from the collision site to the salvage treatment facility.

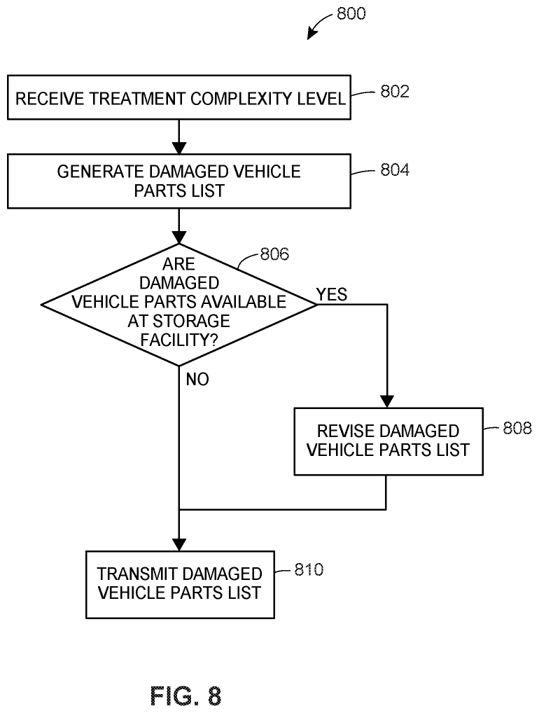

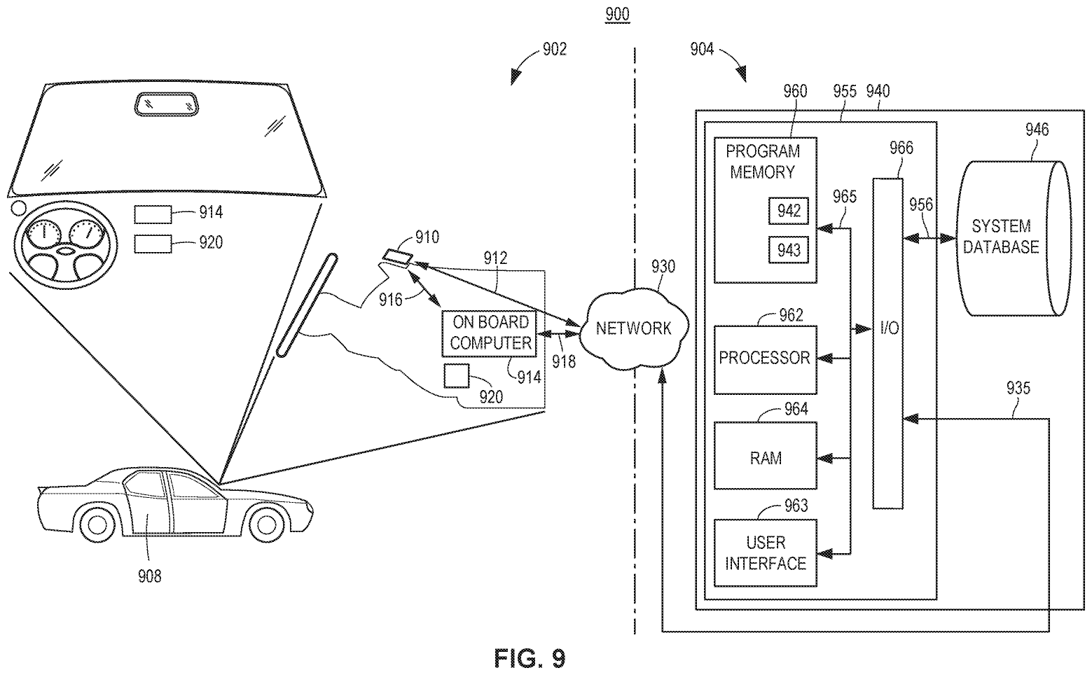

To further facilitate the treatment of the damaged vehicle, additional information may also be transmitted by system personnel and/or the processing center 102 of the treatment system 100. In some instances, a request for a quote to treat the damaged vehicle may be generated and sent to selected treatment facilities (e.g., repair or salvage centers). An exemplary process for including information related to the damaged vehicle with the request for a quote to treat the damaged vehicle is illustrated in the flow diagram 800 shown in FIG. 8. The request for a quote to repair the damaged vehicle may be generated based in part on the vehicle treatment complexity level (block 802) received by system personnel and/or the processing center 102 and/or any other information, such as the make, model, and year of the damaged vehicle, as well as a time and/or monetary limitation.

In particular, a list of damaged vehicle parts may be generated (block 804) by system personnel and/or the processing center 102 and sent to a prospective treatment facility, a prospective vehicle parts supplier, and/or the vehicle owner (block 810). The generated list of damaged vehicle parts may include a list of vehicle parts likely to have been damaged in the crash as reflected by the vehicle treatment complexity level and may be sent along with a request for a quote to repair the damaged vehicle. The quotes received from the various entities may be analyzed and compared by system personnel and/or the processing center 102 to select a repair treatment facility for repairing the damaged vehicle. Such analyses may consider the time to repair the damaged vehicle, the work quality history of the repair treatment facility, etc.

Prior to requesting quotes for repairing the damaged vehicle, system personnel and/or the processing center 102 may compare the list of damaged vehicle parts to an inventory list of undamaged vehicle parts stored at a storage facility 116 or storage center (block 806). The undamaged vehicle parts stored in the storage facility 116 may have been harvested from previously scrapped or salvaged vehicles. System personnel and/or the processing center 102 may revise the list of damaged vehicle parts to indicate any vehicle parts that are available at the storage facility 116 (block 808).

A repair treatment facility quoting to repair the damaged vehicle may then utilize the information from the damaged vehicle parts list in its quote for repairing the damaged vehicle. For example, the prospective repair centers may be provided the opportunity to purchase one or more vehicle parts stored at the storage facility in its repair quote. Additionally, the cost and availability of a particular vehicle part stored at the storage facility may also be presented to the vehicle owner in the form of the damaged vehicle parts list and the like with the opportunity to select and purchase a particular vehicle part from the storage facility 116. The vehicle owner may select and purchase all, none, or some of the vehicle parts held in the storage facility 116.

FIG. 9 illustrates a block diagram of an exemplary treatment system 900 capable of being incorporated into the treatment system 100 shown in FIG. 1 and supporting the processes described herein for treating a vehicle damaged in a crash. The high-level architecture of the vehicle treatment system 900 includes both hardware and software applications, as well as various data communications channels for communicating data between the various hardware and software components. The vehicle treatment system 900 may be divided into front-end components 902 and back-end components 904.

The front-end components 902 include one or more computing devices, such as a mobile computing device 910 and/or an on-board computing device 914. Either computing device 910, 914 may be permanently or removably attached to a vehicle 908 and may interface with various sensors coupled to the vehicle 908 (e.g., a speedometer, an accelerometer, a compass, a global position unit (GPS), etc.) and/or may interface with various external output devices in the vehicle 908, such as one or more tactile alert systems, one or more speakers, one or more displays, etc.

Each of the mobile computing device 910 and the on-board computing device 914 is capable of performing all of the functions of the computing device described herein or may supplement the functions performed by the other computing device. The mobile computing device 910 and on-board computing device 914 may communicate with one another directly over a wired or wireless link 916. In addition, the mobile computing device 910 and the on-board computing device 914 may communicate with a network 930 over wired or wireless links 912, 918, respectively. The network 930 may be a proprietary network, a secure public internet, a virtual private network, or some other type of network, such as dedicated access lines, plain ordinary telephone lines, satellite links, etc., and combinations thereof. Where the network 930 comprises the internet, data communications may take place over the network 930 via an internet communication protocol. As a result, the various computing devices 910, 914, and remote servers may communicate via wireless communication or data transmission over one or more radio frequency links, or wireless or digital communication channels.

The treatment system 900 may also include a notification alert system 920 (e.g., automatic collision notification (ACN), advanced automatic collision or crash notification (AACN), event data recorder (EDR)), that may record and/or transmit information associated with treating the vehicle 908 before or after being involved in a crash. The front-end components 902 and the back-end components 904 communicate via the communication network 930. The back-end components 904 include a computing device such as a server 940 device or system. The server device 940 may include one or more processors 962 adapted and configured to execute various software applications and/or modules of the vehicle treatment system 900, in addition to other software routines. The server device 940 may further include a database 946 adapted to store the various software applications, modules, and/or routines as well as data related to the operation of the vehicle treatment system 900.

The data may include, for example, information collected by the mobile computing device 910 and/or the on-board computing device 914 pertaining to the vehicle treatment system 900 and uploaded to the server device 940, such as sensor inputs, analyses corresponding to the methods discussed above, and images. Other kinds of information that may be stored in the database may include historical vehicle collision data compiled from crash data involving vehicles categorized in the same or similar type of vehicle as the vehicle 908 and contact information relating to vehicle service repair and/or salvage treatment facilities, part suppliers, vehicle transporters, vehicle owner, insurance personnel, etc. The computing devices 910, 914 and/or server device 940 may access or store data and/or software applications in the database 946 when executing various functions and tasks associated with the operation of the vehicle treatment system 900.

Although the vehicle treatment system 900 is shown to include one server device 940, one mobile computing device 910, and one on-board computing device 914, it should be understood that additional server devices 940, mobile computing devices 910, and on-board computing devices 914 may be utilized. For example, the system 900 may include several server devices 940 and numerous mobile computing devices 910, all of which may be interconnected via the network 930. As discussed above, the mobile computing device 910 may perform the various functions described herein in conjunction with the on-board computing device 914 or alone Likewise, the on-board computing device 914 may perform the various functions described herein in conjunction with the mobile computing device 910 or alone. In either instance, the mobile computing device 910 or on-board computing device may not need to be present. Furthermore, the processing performed by the one or more server devices 940 may be distributed among a plurality of server devices 940 configured in an arrangement known as “cloud computing.” This arrangement may provide several advantages, such as, for example, enabling near real-time uploads and downloads of information as well as periodic uploads and downloads of information. This arrangement may provide for a thin-client embodiment of the mobile computing device 910 and/or on-board computing device 914 described herein as well as a primary backup of some or all of the data gathered by the mobile computing device 910 and/or on-board computing device 914. All of the information involved with the treatment system 100, for example, crash information, collision data, VIN data, images, historical loss information, damage evaluation tools, damaged vehicle parts list, inventory of vehicle parts stored at the storage facility, vehicle transporters, treatment centers, customer contact information, insurance agent/entity contact information, etc. may be displayed in a variety of formats at the server device 940, wherein system personnel and/or the processing center 102 is provided access to such information for treating the damaged vehicle.

The server device 940 may have a controller 955 that is operatively connected to the database 946 via a link 956. The controller 955 may also be operatively connected to the network 930 via a communication link 935. It should be noted that, while not shown, additional databases may be linked to the controller 955 in a known manner. The controller 955 may include a program memory 960, a processor 962 (e.g., a microprocessor or a microcontroller), a random-access memory (RAM) 964, input/output (I/O) circuitry 966, and a user interface module 963 all of which may be interconnected via an address/data bus 965. The user interface module 963 facilitates human-to-machine interaction and may include a display screen, keyboard, mouse device, microphone, speaker, etc. Although the I/O circuitry 966 is shown as a single block, the 110 circuitry 966 may include a number of different types of I/O circuits. The program memory 960 may be configured to store computer-readable instructions that when executed by the processor 962 cause the server device 940 to implement a server application 942 and/or a web server 943. The instructions for the server application 942 may cause the server device 940 to implement the methods described herein.

While shown as a single block in FIG. 9, it will be appreciated that the server application 942 may include a number of different programs, modules, routines, sub-routines, etc., that may separately or collectively cause the server device 940 to implement the server application 942. It should also be appreciated that although only one processor 962 is shown, the controller 955 may include multiple processors and/or microprocessors. Similarly, the memory of the controller 955 may include multiple RAMs 964 and multiple program memories 960. The RAM(s) 964 and program memories 960 may be implemented as semiconductor memories, magnetically readable memories, and/or optically readable memories, for example. Further, while the instructions for the server application 942 and web server 943 are shown being stored in the program memory 960, the instructions may additionally or alternatively be stored in the database 946 and/or RAM 964.

Alternatively, the vehicle treatment system 900 may include only the front-end components 902. For example, a mobile computing device 910 and/or on-board computing device 914 may perform any and/or all of the processing associated with compiling or gathering crash information, determining a treatment complexity level based upon the crash information, determining a treatment for the vehicle based upon the a treatment complexity level; and transmitting information associated with the treatment of the vehicle.

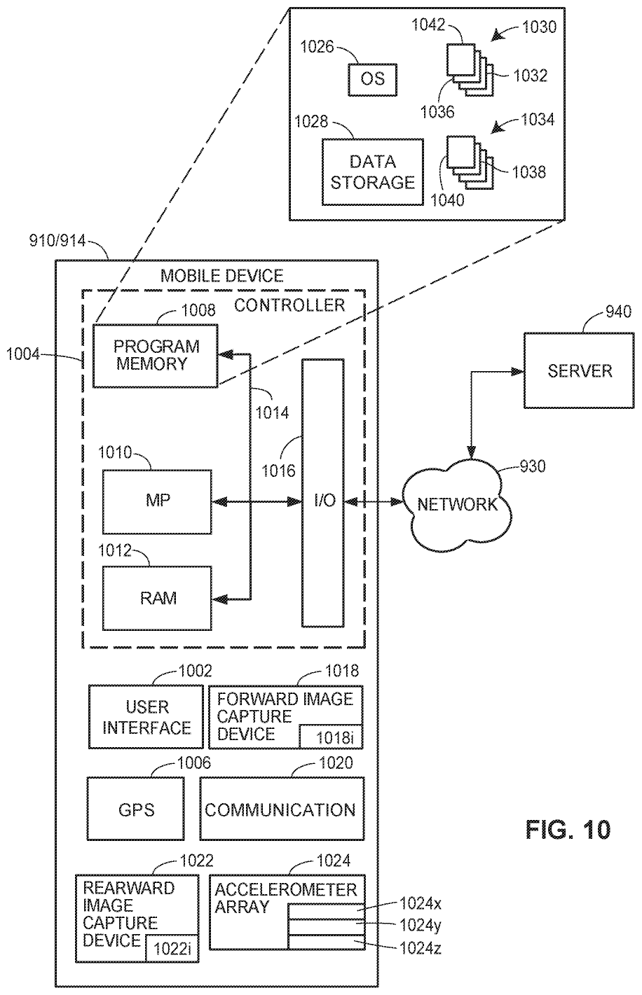

Referring now to FIG. 10, the mobile computing device 910 may include a user interface module 1002, a positioning module 1006 such as a global positioning system (GPS) module, a communication module 1020, a forward image capture module 1018, a rearward image capture module 1022, an accelerometer array 1024, and a controller 1004. Similarly, the on-board computing device 914 may include a user interface module 1002, a GPS module 1006, a communication module 1020, a forward image capture module 1018, a rearward image capture module 1022, an accelerometer array 1024, and a controller 1004.

The mobile computing device 910 and on-board computing device 914 may be integrated into a single device that can perform the functions of both devices. It will be appreciated that functions performed by either the mobile computing device 910 or the on-board computing device 914 may also be performed by the on-board computing device 914 in cooperation with the mobile computing device 910. The mobile computing device 910 may be a general-use mobile personal computer, cellular phone, smartphone, tablet computer, wearable computer (e.g., a watch, glasses, etc.), or a device dedicated to facilitating treatment of a damaged vehicle. The on-board computing device 914 may be a general-use on-board computer capable of performing the functions relating to vehicle operation or dedicated to facilitate treatment of a damaged vehicle. The on-board computing device 914 may be installed by the manufacturer of the vehicle 908 or as an aftermarket modification to the vehicle. Further, the mobile computing device 910 and/or on-board computing device 914 may be a thin-client device that outsources some or most processing to the server device 940.

Similar to the controller 955, the controller 1004 includes a program memory 1008, a microprocessor (MP) 1010, a random-access memory (RAM) 1012, and input/output (I/O) circuitry 1016, all of which are interconnected via an address/data bus 1014. Although the I/O circuitry 1016 is depicted in FIG. 10 as a single block, the I/O circuitry 1016 may include a number of different types of I/O circuits. The program memory 1008 includes an operating system 1026, a data storage device 1028, a plurality of software applications 1030, and a plurality of software routines 1034. The operating system 1026 may include one of a plurality of mobile platforms such as the iOS®, Android™, Palm® webOS, Windows® Mobile/Phone, BlackBerry® OS, or Symbian® OS mobile technology platforms, developed by Apple Inc., Google Inc., Palm Inc. (now Hewlett-Packard Company), Microsoft Corporation, Research in Motion (RIM), and Nokia, respectively. The data storage 1028 may include application data for the plurality of applications 1030, routine data for the plurality of routines 1034, and other data necessary to interact with the server 940 through the network 930. In particular, the data storage device 1028 may include vehicle collision data associated with a vehicle type that includes the vehicle 908. The vehicle type may include the make, model, and year of the vehicle.

The vehicle collision data may include one or more compilations of recorded measurements of damaged vehicle parts and components and the corresponding acceleration and derived vectors (e.g., velocity and direction), of such characteristics attributed for the damage. In some embodiments, the controller 1004 may also include, or otherwise be operatively coupled for communication with other data storage mechanisms (e.g., one or more hard disk drives, optical storage drives, solid state storage devices, etc.) that may reside within the mobile computing device 910 and/or on-board computer 914 or operatively coupled to the network 930 and/or server device 940.

The GPS module 1006 may use “Assisted GPS” (A-GPS), satellite GPS, or any other suitable global positioning protocol or system that locates vehicle 908 via the position of the mobile computing device 910 and/or on-board computing device 914. For example, A-GPS utilizes terrestrial cell phone towers or Wi-Fi hotspots (e.g., wireless router points) to more accurately and more quickly determine the location of the vehicle 908 via the mobile computing device 910 and/or on-board computing device 914 while satellite GPS is generally more useful in more remote regions that lack cell towers or Wi-Fi hotspots. The GPS module 1006 may also facilitate the determination of the velocity and direction of the vehicle 908, via the coupling of the mobile computing device 910 and/or on-board computing device 914 to the vehicle.

The accelerometer array 1024 is one example of a telematics device or module that may incorporate one or more accelerometers positioned to determine the acceleration and direction of movements of the mobile computing device 910 and/or on-board computing device 914, which effectively correlate to the acceleration and direction of movements of the vehicle 908. In some embodiments, the accelerometer array 1024 may include an X-axis accelerometer 1024x, a Y-axis accelerometer 1024y, and a Z-axis accelerometer 1024z to measure the acceleration and direction of movement in each respective dimension. It will be appreciated by those of ordinary skill in the art that a three dimensional vector describing a movement of the vehicle 908 via the mobile computing device 910 and/or on-board computing device 914 through three dimensional space can be established by combining the outputs of the X-axis, Y-axis, and Z-axis accelerometers 1024x, y, z using known methods. Single- and multi-axis models of the accelerometer 1024 are capable of detecting magnitude and direction of acceleration as a vector quantity, and may be used to sense orientation and/or coordinate acceleration of the vehicle 908.

The forward and rearward image capture module 1018, 1022 may be built-in cameras within the mobile computing device 910 and/or on-board computing device 914 and/or may be peripheral cameras, such as webcams, cameras installed inside the vehicle 908, cameras installed outside the vehicle 908, etc., that are communicatively coupled with the mobile computing device 910 and/or on-board computing device 914.

The image capture module 1018, 1022 may be oriented toward the front and rear of the vehicle 908. For example, the forward image capture module 1018 may be oriented toward the front of the vehicle 908 to observe the forward area of the vehicle 908 while the rearward image capture module 1022 may be oriented toward the rear of the vehicle 908 to observe the rearward area of the vehicle 908, or vice-versa. Some embodiments of the treatment system 900 may have both a forward image capture module 1018 and a rearward image capture module 1022, but other embodiments may have only one or no image capture module. Further, either or both of the forward image capture module 1018 and the rearward image capture module 1022 may include an infrared illuminator 1018i, 1022i, respectively, to facilitate low light and/or night image capturing. Such an infrared illuminator 1018i, 1022i may be automatically activated when light is insufficient for image capturing.

The GPS module 1006, the image capture modules 1018, 1022, and the accelerometer array 1024 may be referred to collectively as the “sensors” of the mobile computing device 910 and/or on-board computing device 914. Of course, it will be appreciated that additional GPS modules 1006, image capture modules 1018, 1022, and/or the accelerometer arrays 1024 may be operatively coupled to the mobile computing device 910 and/or on-board computing device 914. Further, the mobile computing device 910 and/or on-board computing device 914 may also include or be coupled to other sensors such as a thermometer, microphone, thermal image capture device, biomedical sensor, etc. The microphone may be incorporated with the user interface module 1002 and used to receive voice inputs from the vehicle operator while the thermometer and/or thermal image capture device may be used to determine fire or heat damage to the vehicle 908, and the biomedical sensor may capture biological characteristics of the vehicle operator.

The communication module 1020 may communicate with the server device 940 via any suitable wired or wireless communication protocol network, such as a wireless telephony network (e.g., GSM, CDMA, LTE, etc.), a Wi-Fi network (802.11 standards), a WiMAX network, a Bluetooth network, etc. The communication unit 1020 may also be capable of communicating using a near field communication standard (e.g., ISO/IEC 18092, standards provided by the NFC Forum, etc.).

The mobile computing device 910 and/or on-board computing device 914 may include the user-input interface 1002, which may include a “soft” keyboard that is presented on a display screen of the mobile computing device 910 and/or on-board computing device 914, an external hardware keyboard communicating via a wired or a wireless connection (e.g., a Bluetooth keyboard), and an external mouse, or any other suitable user-input device or component (see examples in FIGS. 10-13). As described earlier, the user-input module 1002 may also include a microphone (not shown) capable of receiving voice input from a vehicle operator as well as a display screen.

With reference to the controllers 955, 1004, it should be appreciated that although FIG. 10 depicts only one microprocessor 1010, the controller 1004 may include multiple microprocessors 1010. The memory of the controller 1004 may also include multiple RAMs 1012 and multiple program memories 1008. The controller 1004 may implement the RAM 1012 and the program memories 1008 as semiconductor memories, magnetically readable memories, and/or optically readable memories, for example. The one or more processors 1010 may be adapted and configured to execute any of the plurality of software applications 1030 and/or any of the plurality of software routines 1034 residing in the program memory 1008, in addition to other software applications. One of the plurality of applications 1030 may be a client application 1032 that may be implemented as a series of machine-readable instructions for performing the various functions associated with implementing the vehicle treatment system 900 as well as receiving information at, displaying information on, and transmitting information from the mobile device 910 and/or the on-board computing device 914. A client application 1032 may function to implement a system wherein the front-end components 902 communicate and cooperate with back-end components 904 as described above. The client application 1032 may include machine-readable instructions for implementing the user interface 1002 to allow a user to input commands to, and receive information from, the vehicle treatment system 900.

One of the plurality of applications 1030 may be a native web browser 1036, such as Apple's Safari®, Google Android™ mobile web browser, Microsoft Internet Explorer® for Mobile, Opera Mobile™, that may be implemented as a series of machine-readable instructions for receiving, interpreting, and displaying web page information from the server device 940 or other back-end components 904 while also receiving inputs from the vehicle operator. Another application of the plurality of applications may include an embedded web browser 1042 that may be implemented as a series of machine-readable instructions for receiving, interpreting, and displaying web page information from the server device 940 or other back-end components 904 within the client application 1032.

Another of the plurality of client applications 1030 or routines 1034 may include an accelerometer routine 1038 that determines the acceleration and direction of movements of the mobile computing device 910 and/or on-board computing device 914, which correlate to the acceleration and direction of the vehicle 908. The accelerometer routine may process data from the accelerometer array 1024 to determine one or more vectors describing the motion of the vehicle 908 for use with the client application 1032. In some embodiments where the accelerometer array 1024 has X-axis, Y-axis, and Z-axis accelerometers 1024x,y,z, the accelerometer routine 1038 may combine the data from each accelerometer 1024x,y,z to establish the vectors describing the motion of the vehicle 908 as it moves through three dimensional space. In some embodiments, the accelerometer routine 1038 may use data pertaining to less than three axes.

Another routine in the plurality of applications 1030 or routines 1034 may include a vehicle velocity routine 1040 that coordinates with the GPS module 1006 to retrieve vehicle velocity and direction information for use with one or more of the plurality of applications, such as the client application 1032, or for use with other routines.

Yet another routine in the plurality of applications 1030 or routines 1034 may include an image capture routine that coordinates with the image capture modules 1018, 1022 to retrieve image data for use with one or more of the plurality of applications, such as the client application 1032, or for use with other routines.

The user or vehicle operator may also launch or instantiate any other suitable user interface application (e.g., the native web browser 1036, or any other one of the plurality of software applications 1030) to access the server device 940 to implement the vehicle treatment system 900. Additionally, the user or vehicle operator may launch the client application 1032 from the mobile computing device 910 and/or on-board computing device 914, to access the server device 940 to implement the vehicle treatment system 900.

After the vehicle operating information (e.g., acceleration, velocity, and direction) has been gathered or determined by the sensors or the mobile computing device 910 and/or on-board computing device 914, previously recorded collision data may be utilized to determine the extent of damage to the vehicle 908 involved in a crash, or if and when the vehicle 908 is involved in a crash. Once the extent of the damage has been assessed, a treatment for the vehicle 908 can be determined. For example, the mobile computing device 910 and/or on-board computing device 914 may determine that the damaged vehicle can be repaired or scrapped, and where the damaged vehicle may be taken for such treatment. The mobile computing device 910 and/or on-board computing device 914 may also transmit information associated with the treatment of the damaged vehicle. For example, the transmitted information may be sent to a treatment facility capable of performing the treatment and/or the information may be sent to a transportation facility and include a request to transport the damaged vehicle to the treatment facility.

In embodiments where the mobile computing device 910 and/or on-board computing device 914 is a thin-client device, the server device 940 may perform many of the processing functions remotely that may otherwise be performed by system personnel and/or the mobile computing device 910 and/or on-board computing device 914. In such embodiments, the server device 940 may include a number of software applications capable of receiving vehicle operating information gathered by the sensors and/or acquiring collision data to be used in determining the extent of damage to the vehicle 908 involved in the crash, or estimating the extent of damage to the vehicle 908 before it is involved in a crash. For example, the mobile computing device 910 and/or on-board computing device 914 may gather information from its sensors as described herein, but instead of using the information locally, the mobile computing device 910 and/or on-board computing device 914 may send the information to the server device 940 for remote processing. The server device 940 may perform the analysis of the gathered crash information to determine the amount of damage to the vehicle 908, and/or perform the analysis of the gathered pre-crash information to determine the estimated extent of damage if and when the vehicle 908 is involved in a crash, as described herein. The server device 940 may then determine whether the vehicle can be repaired or scrapped, and where the vehicle may be taken for such treatment. The server device 940 may also transmit information associated with the treatment of the damaged vehicle. For example, the information transmitted by the server device 940 may be sent to a treatment facility and/or a transport facility and include a request to transport the damaged vehicle to the treatment facility, or the server device 940 may transmit the information to the mobile computing device 910 and/or on-board computing device 914.

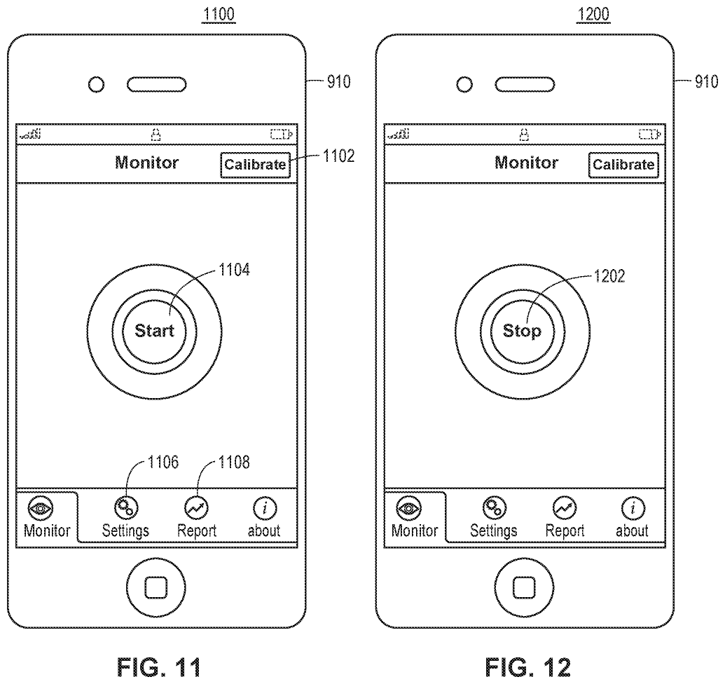

FIGS. 11-14 depict application pages that may be presented on the user interface 1002 of the mobile computing device 910 as part of the user interface used to implement the vehicle treatment system 900. While FIGS. 11-14 depict pages or screens of information capable of being presented on the display 1002 of the mobile computing device 910, it is to be understood that the application pages or screens of information could be displayed on the display 1002 of the on-board computing device 914 in addition to being displayed on the mobile device 910 or as an alternative. In addition, the application pages may also be displayed on the user interface 963 of the server device 940. The applications or pages may be generated by the mobile computing device 910/914 or sent to the mobile computing device 910/914 by the server 940 (e.g., as with a thin client).

The user may launch the application from the mobile computing device 910/914 via any suitable manner, such as touch-selecting a start application icon 1104 on the display 1002 of the mobile computing device 910/914 or speaking a voice command into the microphone (not shown) of the mobile computing device 910/914. After the user launches the application 1032, the application 1032 may begin to run on the mobile computing device 910/914 as described above in connection to block 202, FIG. 2A and/or FIG. 2B; or the mobile computing device 910 may communicate with the on-board computing device 914 and the client application 1032 may begin to run on the on-board computing device 914.

With reference now to FIG. 11, a monitor screen 1100 of the client application and/or routine may be displayed on the screen of the mobile computing device 910/914. The monitor screen 1100 may include a “Calibrate” tab 1102, a “Start” tab 1104, a “Settings” tab 1106, and a ‘Report’ tab 1108. When the user selects the “Calibrate” tab 1102, the client application may execute a calibration routine. A calibration screen (not shown) may be displayed on the screen of the mobile computing device 910/914 during execution of the calibration routine, wherein the progress of the calibration routine may be indicated by an illustration showing the approximate status of the calibration routine. If desired, a user may cancel the calibration and/or set the calibration routine to run in the “background,” so as not to appear on the screen 1100 of the mobile computing device 910/914.

When the user selects the “Start” tab 1104, the client application may begin to monitor and collect data about vehicle operation. The collected data may be stored as described above and/or additional data may be mathematically determined from the collected data about vehicle operation and also stored. Once started, a vehicle monitor screen 1200 shown in FIG. 12 may be displayed on the screen of the mobile computing device 910/914. The vehicle monitor screen 1200 may include a “Stop” tab 1202. If the “Stop” tab 1202 is selected by the user, the vehicle treatment system 900 will terminate vehicle operation monitoring. The vehicle treatment system 900 may also be stopped by a voice command of the user. Alternatively, the vehicle treatment system 900 (e.g., gathering and analyzing of the vehicle operation and/or collision data), may be ceased by the mobile computing device 910/914 detecting that the engine of the vehicle 908 has stopped.

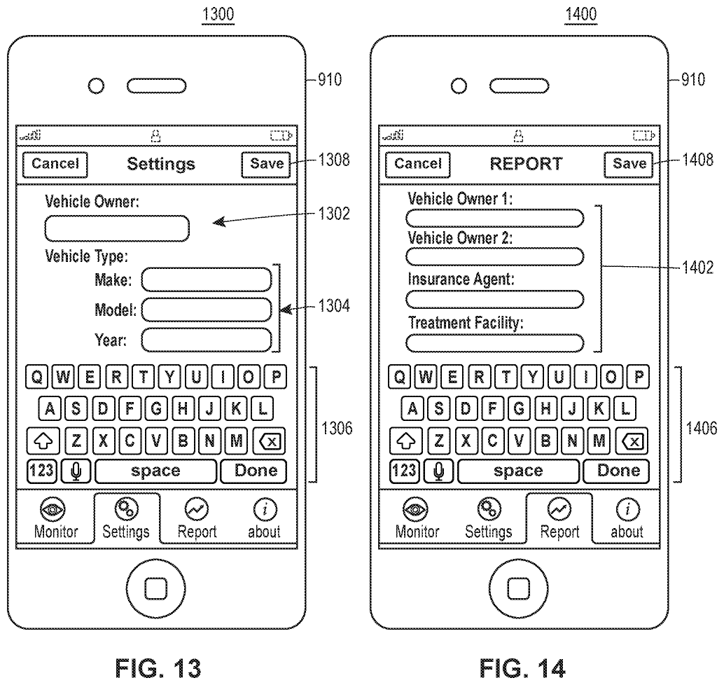

Referring now to FIG. 13, when the user selects the “Settings” tab 1106 shown in FIG. 11, a settings screen 1300 may be displayed on the screen of the mobile computing device 910/914. The settings screen 1300 may include a variety of information that the user or vehicle operator may enter into the vehicle treatment system 900 via a “soft” keyboard 1306 of the user interface of the mobile computing device 910/914. Such information may include the vehicle owner's name and/or contact information 1302.

Additional information may include the make, model, and year of the vehicle type 1304 of the vehicle 908 that will be utilized with the treatment system 900. The settings screen 1300 may also include a variety of parameters that may be entered and adjusted by the user, such as the mode for turning on the treatment system 900(i.e., manual or automatic, etc.). The parameters may be modified and saved by the user or vehicle operator via selection of a “Save” tab 1308 of the user interface on the mobile computing device 910/914.

Referring now to FIG. 14, when the user selects the “Report” tab 1108 shown in FIG. 11, a report screen 1400 may be displayed on the screen of the mobile device 910/914. The report screen 1400 may include a list of contacts 1402 to be notified in the event of a crash. The contact list 1402 may include the vehicle owner, insurance agent, etc., and may be entered and/or modified by the user via a “soft” keyboard 1406 of a user interface of the mobile computing device 910. The list of contacts 1402 may be saved by the user or vehicle operator via selection of the “Save” tab 1408 of the user interface of the mobile computing device 910.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain operations may be distributed among the one or more processors, not only residing within a single machine, but deployed across a number of machines. In some exemplary embodiments, the processor or processors may be located in a single location (e.g., within a home environment, an office environment or as a server farm), while in other embodiments the processors may be distributed across a number of locations.

The performance of certain operations may be distributed among the one or more processors, not only residing within a single machine, but deployed across a number of machines. In some exemplary embodiments, the one or more processors or processor-implemented modules may be located in a single geographic location (e.g., within a home environment, an office environment, or a server farm). In other exemplary embodiments, the one or more processors or processor-implemented modules may be distributed across a number of geographic locations.

### Machine Learning and Other Matters

In certain embodiments, the machine learning techniques, such as cognitive learning, deep learning, combined learning, heuristic engines and algorithms, and/or pattern recognition techniques. For instance, a processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image, mobile device, insurer database, and/or third-party database data, including the historical auto insurance claim data discussed herein. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract the relevant data for one or more user device details, user request or login details, user device sensors, geolocation information, image data, the insurer database, a third-party database, and/or other data.

In one embodiment, a processing element (and/or machine learning or heuristic engine or algorithm discussed herein) may be trained by providing it with a large sample of images and/or user data with known characteristics or features, such as historical vehicle data and/or past auto claim data. Based upon these analyses, the processing element may learn how to identify characteristics and patterns that may then be applied to analyzing user device details, user vehicle details, user device sensors, geolocation information, image data, the insurer database, a third-party database, and/or other data. For example, the processing element may learn, with the user's permission or affirmative consent, to identify the user and/or insured vehicles, and/or learn to identify insured vehicles characteristics. The processing element may also be able to predict which vehicles are more prone to be classified as a total loss in the event of a vehicle collision, such as by vehicle characteristics determined from vehicle or other data.

The processing element and/or machine learning algorithm may determine historical storage, rental, or salvage time and/or costs typically expected with various types of vehicles or with vehicles having specific characteristics (such as make, model, mileage, age, etc.)—such as by analysis of scrubbed or depersonalized historical or past auto claim data. As such, a total loss may be predicted when a given vehicle is involved in a vehicle collision, and if so, the total loss cycle time may be reduced, and inconvenience to the insured may be reduced.

### Exemplary Method Embodiments

In one aspect, a computer-implemented method for treating a vehicle damaged in a crash may be provided. The method may include: (1) receiving, at one or more processors and/or transceivers before a vehicle is damaged in a crash, pre-crash information about the vehicle, the pre-crash information including (i) data being transmitted by a customer mobile device or vehicle computer (via wireless communication or data transmission over one or more radio links, or wireless or digital communication channels), and/or (ii) data being retrieved from a memory unit; (2) determining, by the one or more processors before the vehicle is damaged in a crash, a treatment complexity level associated with treating the vehicle after a crash based upon the received pre-crash information, the treatment complexity level including a value of the vehicle and a price schedule for treating the damaged vehicle, wherein treating the damaged vehicle includes repairing, salvaging, or scrapping the damaged vehicle; (3) selecting, by the one or more processors, a treatment facility for treating the vehicle based upon the determined treatment complexity level, reputation for the treatment facility, and/or location of the treatment facility; and/or (4) transmitting, by the one or more processors and/or transceivers, information associated with transporting the damaged vehicle to a selected treatment facility computing device (such as via wireless communication or data transmission over one or more radio links, or wireless or digital communication channels) to facilitate expediting total loss processing.

In another aspect, a computer-implemented method for processing a vehicle damaged in a crash may be provided. The method may include: (1) receiving, at one or more processors and/or transceivers before receiving notice of a vehicle being damaged in a crash, pre-crash information about the vehicle, the pre-crash information including (i) data being transmitted by a customer mobile device or vehicle computer (via wireless communication or data transmission over one or more radio links, or wireless or digital communication channels), or (ii) data retrieved from a memory unit; (2) determining, by the one or more processors before receiving notice of the vehicle being damaged in a crash, whether a likelihood of a total loss of the damaged vehicle is greater than a predetermined threshold based upon the received pre-crash information, wherein the total loss of the damaged vehicle comprises a cost of treating the damaged vehicle based upon a price schedule for treating the damaged vehicle being greater than a predetermined percentage of a value of the vehicle independent of a severity of actual damage after the vehicle is damaged in a crash; (3) receiving, at the one or more processors and/or transceivers, electronic notice of the vehicle being damaged in a crash, the electronic notice comprising an insurance claim for the damage to the vehicle, the electronic notice including data being transmitted by a customer mobile device or vehicle computer (via wireless communication or data transmission over one or more radio links, or wireless or digital communication channels); and/or (4) automatically offering, via the one or more processors and/or transceivers, an electronic insurance settlement for an insured value of the damaged vehicle if the likelihood of a total loss of the damaged vehicle is greater than the predetermined threshold (such as by generating and transmitting an electronic settlement offer to the insured's mobile device for their review and approval via wireless communication or data transmission over one or more radio links, or wireless or digital communication channels), the electronic insurance settlement comprising a value for a total loss of the vehicle independent of the severity of actual damage after the vehicle is damaged in the crash, to facilitate total loss processing.

In another aspect, a computer-implemented method for processing a vehicle damaged in a crash may be provided. The method may include: (1) receiving, at one or more processors and/or transceivers before receiving notice of a vehicle being damaged in a crash, pre-crash information about the vehicle, the pre-crash information including (i) data being transmitted by a customer mobile device or vehicle computer (via wireless communication or data transmission over one or more radio links, or wireless or digital communication channels), or (ii) data retrieved from a memory unit; (2) determining, by the one or more processors before receiving notice of the vehicle being damaged in a crash, whether a likelihood of a total loss of the damaged vehicle is greater than a predetermined threshold based upon the received pre-crash information, wherein the total loss of the damaged vehicle comprises a cost of treating the damaged vehicle based upon a price schedule for treating the damaged vehicle being greater than a predetermined percentage of a value of the vehicle independent of a severity of actual damage after the vehicle is damaged in a crash; (3) receiving, at the one or more processors and/or transceivers, electronic notice of the vehicle being damaged in a crash, the electronic notice comprising an insurance claim for the damage to the vehicle, the electronic notice including data being transmitted by a customer mobile device or vehicle computer (via wireless communication or data transmission over one or more radio links, or wireless or digital communication channels); (4) determining, at the one or more processors, a GPS (Global Positioning System) location of the vehicle from the data received from customer mobile device or vehicle computer; (5) determining, at the one or more processors, a best or reputable salvage facility in proximity or within a predetermined distance of the GPS location (such as within 5, 10, 15, or 30 miles); and/or (4) requesting, via the one or more processors and/or transceivers (with customer permission received from their mobile device), the salvage facility (or a salvage facility remote server) to arrange and/or pick up the damaged vehicle at the GPS location and process it as salvage (such as via wireless communication or data transmission over one or more radio links, or wireless or digital communication channels) to facilitate expediting the total loss process and enhance the customer experience.

The method may further include automatically offering, via the one or more processors and/or transceivers, an electronic insurance settlement for an insured value of the damaged vehicle if the likelihood of a total loss of the damaged vehicle is greater than the predetermined threshold (such as by generating and transmitting an electronic settlement offer to the insured's mobile device for their review and approval via wireless communication or data transmission over one or more radio links, or wireless or digital communication channels), the electronic insurance settlement comprising a value for a total loss of the vehicle independent of the severity of actual damage after the vehicle is damaged in the crash.

In another aspect, a computer-implement method for treating a vehicle damaged in a crash may be provided. The method may include: (1) receiving, via the one or more processors and/or transceivers, a VIN (Vehicle Identification Number) of a vehicle involved in a vehicle (such as via wireless communication or data transmission over one or more radio links, or wireless or digital communication channels), the VIN being transmitted by a customer mobile device, a vehicle controller or processor, or smart infrastructure, or being retrieve from a memory unit; (2) determining, via the one or more processors, one or more vehicle characteristics for the vehicle using or based upon the VIN; (3) inputting, via the one or more processors, the one or more vehicle characteristics for the vehicle into a machine learning program that is trained to identify that a specific vehicle has a higher than average probability that, if involved in a vehicle collision, that specific vehicle will be characterized as a “total loss” based upon the one or more characteristics of that specific vehicle; (4) if the machine learning program determines that the vehicle is likely a total loss based upon the vehicle's one or more vehicle characteristics, then determining, at the one or more processors, a GPS (Global Positioning System) location of the vehicle from the data received from the customer mobile device, the vehicle controller or processor, or the smart infrastructure; (5) determining, at the one or more processors, a best or reputable salvage facility in proximity or within a predetermined distance of the GPS location (such as within 5, 10, 15, or 30 miles); and/or (6) requesting, via the one or more processors and/or transceivers (with customer permission received from their mobile device), the salvage facility to arrange and/or pick up the damaged vehicle at the GPS location and process it as salvage (such as via wireless communication or data transmission over one or more radio links, or wireless or digital communication channels) to facilitate expediting the total loss process and enhance the customer experience.

The method may further include automatically offering, via the one or more processors and/or transceivers, an insurance settlement for an insured value of the damaged vehicle if the likelihood of a total loss of the damaged vehicle is greater than the predetermined threshold (such as by generating and transmitting an electronic settlement offer to the insured's mobile device for their review and approval via wireless communication or data transmission over one or more radio links, or wireless or digital communication channels), the insurance settlement comprising a value for a total loss of the vehicle independent of the severity of actual damage after the vehicle is damaged in the crash. The method may further include inputting, via one or more processors, depersonalized historical auto claim data into the machine learning program to train it to identify which vehicle characteristics indicate that a given vehicle has a higher than average probability that, if involved in a vehicle collision, the vehicle will be characterized as a “total loss”.

The machine learning program may determine an average storage value associated with a storage time (for a total loss) for vehicles having a given set of characteristics, and if the average storage value is greater than a predetermined amount, then those given characteristics are weighted in favor of likelihood that a vehicle collision will be a total loss. The machine learning program may determine an average rental value (for a total loss) associated with vehicles having a given set of characteristics, and if the average rental value is greater than a predetermined amount, then those given characteristics are weighted in favor of likelihood that a vehicle collision will be a total loss. The machine learning program may determine an average salvage time or cost (for a total loss) associated with vehicles having a given set of characteristics, and if the average salvage time or cost is greater than a predetermined amount, then those given characteristics are weighted in favor of likelihood that a vehicle collision will be a total loss. The vehicle characteristics identified may include vehicle make, model, age, height, weight, and/or mileage.

In another aspect, a computer-implemented method for treating a vehicle damaged in a crash may be provided. The method may include: (1) receiving, via the one or more processors and/or transceivers, image data of a vehicle involved in a vehicle (such as via wireless communication or data transmission over one or more radio links, or wireless or digital communication channels), the image data being transmitted by a customer mobile device, a vehicle controller or processor, or smart infrastructure; (2) determining, via the one or more processors, one or more vehicle characteristics for the vehicle using the image data (such as via optical character recognition, object recognition, or pattern recognition techniques), or alternatively using the image data to identify the vehicle VIN, and then determining the one or more vehicle characteristics using the vehicle VIN; (3) inputting, via the one or more processors, the one or more vehicle characteristics for the vehicle into a machine learning program that is trained to identify that a specific vehicle has a higher than average probability that, if involved in a vehicle collision, that specific vehicle will be characterized as a “total loss” based upon one or more characteristics of that specific vehicle; (4) if the machine learning program determines that the vehicle is likely a total loss based upon the vehicle's one or more vehicle characteristics, then determining, at the one or more processors, a GPS (Global Positioning System) location of the vehicle from the data received from the customer mobile device, the vehicle controller or processor, or the smart infrastructure; (5) determining, at the one or more processors, a best or reputable salvage facility in proximity or within a predetermined distance of the GPS location (such as within 5, 10, 15, or 30 miles) of the vehicle collision; and/or (6) requesting, via the one or more processors and/or transceivers (with customer permission received from their mobile device), the salvage facility to arrange and/or pick up the damaged vehicle at the GPS location and process it as salvage (such as via wireless communication or data transmission over one or more radio links, or wireless or digital communication channels) to facilitate expediting the total loss process and enhance the customer experience.

The method may further include automatically offering, via the one or more processors and/or transceivers, an insurance settlement for an insured value of the damaged vehicle if the likelihood of a total loss of the damaged vehicle is greater than the predetermined threshold (such as by generating and transmitting an electronic settlement offer to the insured's mobile device for their review and approval via wireless communication or data transmission over one or more radio links, or wireless or digital communication channels), the insurance settlement comprising a value for a total loss of the vehicle independent of the severity of actual damage after the vehicle is damaged in the crash. The method may further include inputting, via one or more processors, depersonalized historical auto claim data (or claim data with customer permission) into the machine learning program to train it to identify which vehicle characteristics indicate that a given vehicle has a higher than average probability that, if involved in a vehicle collision, that it will be characterized as a “total loss.”

The machine learning program may determine an average storage value associated with a storage time for vehicles having given characteristics, and if the average storage value is greater than a predetermined amount, then those given characteristics are weighted in favor of likelihood of total loss. The machine learning program may determine an average rental value associated with vehicles having given characteristics, and if the average rental value is greater than a predetermined amount, then those given characteristics are weighted in favor of likelihood of total loss. The machine learning program determines an average salvage time or cost associated with vehicles having given characteristics, and if the average salvage time or cost is greater than a predetermined amount, then those given characteristics are weighted in favor of likelihood of total loss. The vehicle characteristics identified may include vehicle make, model, age, height, weight, material, frame, and/or mileage.

In another aspect, a method implemented on a computer system for treating a vehicle damaged in a crash may be provided. The method may include: (1) receiving, at the computer system before a vehicle is damaged in a crash, pre-crash information about the vehicle; (2) inputting, by one or more processors before the vehicle is damaged in a crash, the pre-crash information about the vehicle into a machine learning program trained to identify a treatment complexity level associated with treating the vehicle after a crash based upon the received pre-crash information, the treatment complexity level including a value of the vehicle and a price schedule for treating the damaged vehicle, wherein treating the damaged vehicle includes repairing, salvaging, or scrapping the damaged vehicle; (3) selecting, by the one or more processors, a treatment facility for treating the vehicle based upon the determined treatment complexity level; and/or (4) transmitting, by the one or more processors, information associated with transporting the damaged vehicle to the selected treatment facility, with the customer's permission, to facilitate expediting the total loss processing.

The method may further include inputting, via one or more processors, depersonalized historical auto claim data (or auto claim data with customer permission or affirmative consent) into the machine learning program to train it to identify treatment complexity level associated with treating an individual vehicle after a crash based upon the corresponding or received pre-crash information.

In another aspect, a method implemented on a computer system for processing a vehicle damaged in a crash may be provided. The method may include: (1) receiving, at the computer system before receiving notice of a vehicle being damaged in a crash, pre-crash information about the vehicle; (2) inputting, by one or more processors before receiving notice of the vehicle being damaged in a crash, the pre-crash information about the vehicle into a machine learning program trained to identify whether a likelihood of a total loss of the damaged vehicle is greater than a predetermined threshold based upon the received pre-crash information, wherein the total loss of the damaged vehicle comprises a cost of treating the damaged vehicle based upon a price schedule for treating the damaged vehicle being greater than a predetermined percentage of a value of the vehicle independent of a severity of actual damage after the vehicle is damaged in a crash; (3) receiving notice of the vehicle being damaged in a crash, the notice comprising an insurance claim for the damage to the vehicle; and/or (4) automatically offering an insurance settlement for an insured value of the damaged vehicle if the likelihood of a total loss of the damaged vehicle is greater than the predetermined threshold, the insurance settlement comprising a value for a total loss of the vehicle independent of the severity of actual damage after the vehicle is damaged in the crash, to facilitate expediting total loss processing.

The method may further include inputting, via one or more processors, depersonalized historical auto claim data (or auto claim data with customer permission or affirmative consent) into the machine learning program to train it to identify whether a likelihood of a total loss of the damaged vehicle is greater than a predetermined threshold based upon the received pre-crash information.

### Exemplary Computer Systems & Computer-Implemented Methods

In one aspect, a computer system configured to treat a vehicle damaged in a crash may be provided. The computer system may include one or more local or remote processors, servers, sensors, and/or transceivers configured to: (1) receive before a vehicle is damaged in a crash, pre-crash information about the vehicle, the pre-crash information including (i) data being transmitted by a customer mobile device or vehicle computer (via wireless communication or data transmission over one or more radio links, or wireless or digital communication channels), and/or (ii) data being retrieved from a memory unit; (2) determine before the vehicle is damaged in a crash, a treatment complexity level associated with treating the vehicle after a crash based upon the received pre-crash information, the treatment complexity level including a value of the vehicle and a price schedule for treating the damaged vehicle, wherein treating the damaged vehicle includes repairing, salvaging, or scrapping the damaged vehicle; (3) select a treatment facility for treating the vehicle based upon the determined treatment complexity level, reputation for the treatment facility, and/or location of the treatment facility; and/or (4) transmit information associated with transporting the damaged vehicle to a selected treatment facility computing device (such as via wireless communication or data transmission over one or more radio links, or wireless or digital communication channels) to facilitate expediting total loss processing.

In another aspect, a computer system configured to process a vehicle damaged in a crash may be provided. The computer system may include one or more local or remote processors, servers, sensors, and/or transceivers configured to: (1) receive before receiving notice of a vehicle being damaged in a crash, pre-crash information about the vehicle, the pre-crash information including (i) data being transmitted by a customer mobile device or vehicle computer (via wireless communication or data transmission over one or more radio links, or wireless or digital communication channels), or (ii) data retrieved from a memory unit; (2) determine before receiving notice of the vehicle being damaged in a crash, whether a likelihood of a total loss of the damaged vehicle is greater than a predetermined threshold based upon the received pre-crash information, wherein the total loss of the damaged vehicle comprises a cost of treating the damaged vehicle based upon a price schedule for treating the damaged vehicle being greater than a predetermined percentage of a value of the vehicle independent of a severity of actual damage after the vehicle is damaged in a crash; (3) receive electronic notice of the vehicle being damaged in a crash, the electronic notice comprising an insurance claim for the damage to the vehicle, the electronic notice including data being transmitted by a customer mobile device or vehicle computer (via wireless communication or data transmission over one or more radio links, or wireless or digital communication channels); and/or (4) automatically offer an electronic insurance settlement for an insured value of the damaged vehicle if the likelihood of a total loss of the damaged vehicle is greater than the predetermined threshold (such as by generating and transmitting an electronic settlement offer to the insured's mobile device for their review and approval via wireless communication or data transmission over one or more radio links, or wireless or digital communication channels), the electronic insurance settlement comprising a value for a total loss of the vehicle independent of the severity of actual damage after the vehicle is damaged in the crash, to facilitate total loss processing.

In another aspect, a computer system configured to process a vehicle damaged in a crash may be provided. The computer system comprising one or more local or remote processors, servers, sensors, and/or transceivers configured to: (1) receive before receiving notice of a vehicle being damaged in a crash, pre-crash information about the vehicle, the pre-crash information including (i) data being transmitted by a customer mobile device or vehicle computer (via wireless communication or data transmission over one or more radio links, or wireless or digital communication channels), or (ii) data retrieved from a memory unit; (2) determine before receiving notice of the vehicle being damaged in a crash, whether a likelihood of a total loss of the damaged vehicle is greater than a predetermined threshold based upon the received pre-crash information, wherein the total loss of the damaged vehicle comprises a cost of treating the damaged vehicle based upon a price schedule for treating the damaged vehicle being greater than a predetermined percentage of a value of the vehicle independent of a severity of actual damage after the vehicle is damaged in a crash; (3) receive electronic notice of the vehicle being damaged in a crash, the electronic notice comprising an insurance claim for the damage to the vehicle, the electronic notice including data being transmitted by a customer mobile device or vehicle computer (via wireless communication or data transmission over one or more radio links, or wireless or digital communication channels); (4) determine a GPS (Global Positioning System) location of the vehicle from the data received from customer mobile device or vehicle computer; (5) determine a best or reputable salvage facility in proximity or within a predetermined distance of the GPS location (such as within 5, 10, 15, or 30 miles); and/or (6) request (with customer permission received from their mobile device) the salvage facility (or a salvage facility remote server) to arrange and/or pick up the damaged vehicle at the GPS location and process it as salvage (such as via wireless communication or data transmission over one or more radio links, or wireless or digital communication channels) to facilitate expediting the total loss process and enhance the customer experience.

The systems may be further configured to: automatically offer an electronic insurance settlement for an insured value of the damaged vehicle if the likelihood of a total loss of the damaged vehicle is greater than the predetermined threshold (such as by generating and transmitting an electronic settlement offer to the insured's mobile device for their review and approval via wireless communication or data transmission over one or more radio links, or wireless or digital communication channels), the electronic insurance settlement comprising a value for a total loss of the vehicle independent of the severity of actual damage after the vehicle is damaged in the crash.

In another aspect, a computer system configured to treat a vehicle damaged in a crash may be provided. The computer system may include one or more local or remote processors, servers, sensors, and/or transceivers configured to: (1) receive a VIN of a vehicle involved in a vehicle (such as via wireless communication or data transmission over one or more radio links, or wireless or digital communication channels), the VIN being transmitted by a customer mobile device, a vehicle controller or processor, or smart infrastructure, or being retrieve from a memory unit; (2) determine one or more vehicle characteristics for the vehicle using or based upon the VIN; (3) input the one or more vehicle characteristics for the vehicle into a machine learning program that is trained to identify that a specific vehicle has a higher than average probability that, if involved in a vehicle collision, that specific vehicle will be characterized as a “total loss” based upon the one or more characteristics of that specific vehicle; (4) if the machine learning program determines that the vehicle is likely a total loss based upon the vehicle's one or more vehicle characteristics, then determine a GPS (Global Positioning System) location of the vehicle from the data received from the customer mobile device, the vehicle controller or processor, or the smart infrastructure; (5) determine a best or reputable salvage facility in proximity or within a predetermined distance of the GPS location (such as within 5, 10, 15, or 30 miles); and/or (6) request (with customer permission received from their mobile device) the salvage facility to arrange and/or pick up the damaged vehicle at the GPS location and process it as salvage (such as via wireless communication or data transmission over one or more radio links, or wireless or digital communication channels) to facilitate expediting the total loss process and enhance the customer experience.

The computer system may be further configured to: automatically offer an insurance settlement for an insured value of the damaged vehicle if the likelihood of a total loss of the damaged vehicle is greater than the predetermined threshold (such as by generating and transmitting an electronic settlement offer to the insured's mobile device for their review and approval via wireless communication or data transmission over one or more radio links, or wireless or digital communication channels), the insurance settlement comprising a value for a total loss of the vehicle independent of the severity of actual damage after the vehicle is damaged in the crash.

The computer system may be further configured to: input depersonalized historical auto claim data, or auto claim data with customer permission, into the machine learning program to train it to identify which vehicle characteristics indicate that a given vehicle has a higher than average probability that, if involved in a vehicle collision, the vehicle will be characterized as a “total loss.”

The machine learning program may determine an average storage value associated with a storage time (for a total loss) for vehicles having a given set of characteristics, and if the average storage value is greater than a predetermined amount, then those given characteristics are weighted in favor of likelihood that a vehicle collision will be a total loss. The machine learning program may determine an average rental value (for a total loss) associated with vehicles having a given set of characteristics, and if the average rental value is greater than a predetermined amount, then those given characteristics are weighted in favor of likelihood that a vehicle collision will be a total loss. The machine learning program may determine an average salvage time or cost (for a total loss) associated with vehicles having a given set of characteristics, and if the average salvage time or cost is greater than a predetermined amount, then those given characteristics are weighted in favor of likelihood that a vehicle collision will be a total loss. The vehicle characteristics identified may include vehicle make, model, age, height, weight, and/or mileage.

In another aspect, a computer system configured to treat a vehicle damaged in a crash may be provided. The computer system may include one or more local or remote processors, sensors, servers, and/or transceivers configured to: (1) receive image data of a vehicle involved in a vehicle (such as via wireless communication or data transmission over one or more radio links, or wireless or digital communication channels), the image data being transmitted by a customer mobile device, a vehicle controller or processor, or smart infrastructure; (2) determine one or more vehicle characteristics for the vehicle using the image data (such as via optical character recognition, object recognition, or pattern recognition techniques), or alternatively using the image data to identify the vehicle VIN, and then determining the one or more vehicle characteristics using the vehicle VIN; (3) input the one or more vehicle characteristics for the vehicle into a machine learning program that is trained to identify that a specific vehicle has a higher than average probability that, if involved in a vehicle collision, that specific vehicle will be characterized as a “total loss” based upon one or more characteristics of that specific vehicle; (4) if the machine learning program determines that the vehicle is likely a total loss based upon the vehicle's one or more vehicle characteristics, then determine a GPS (Global Positioning System) location of the vehicle from the data received from the customer mobile device, the vehicle controller or processor, or the smart infrastructure; (5) determine a best or reputable salvage facility in proximity or within a predetermined distance of the GPS location (such as within 5, 10, 15, or 30 miles) of the vehicle collision; and/or (6) request (with customer permission received from their mobile device) the salvage facility to arrange and/or pick up the damaged vehicle at the GPS location and process it as salvage (such as via wireless communication or data transmission over one or more radio links, or wireless or digital communication channels) to facilitate expediting the total loss process and enhance the customer experience.

The system may be further configured to: automatically offer an insurance settlement for an insured value of the damaged vehicle if the likelihood of a total loss of the damaged vehicle is greater than the predetermined threshold (such as by generating and transmitting an electronic settlement offer to the insured's mobile device for their review and approval via wireless communication or data transmission over one or more radio links, or wireless or digital communication channels), the insurance settlement comprising a value for a total loss of the vehicle independent of the severity of actual damage after the vehicle is damaged in the crash. The system may be further configured to: input depersonalized historical auto claim data (or claim data with customer permission) into the machine learning program to train it to identify which vehicle characteristics indicate that a given vehicle has a higher than average probability that, if involved in a vehicle collision, that it will be characterized as a “total loss.”

The machine learning program may determine an average storage value associated with a storage time for vehicles having a given set of characteristics, and if the average storage value is greater than a predetermined amount, then those given characteristics are weighted in favor of likelihood of total loss. The machine learning program may determine an average rental value associated with vehicles having a given set of characteristics, and if the average rental value is greater than a predetermined amount, then those given characteristics are weighted in favor of likelihood of total loss. The machine learning program may determine an average salvage time or cost associated with vehicles having a given set of characteristics, and if the average salvage time or cost is greater than a predetermined amount, then those given characteristics are weighted in favor of likelihood of total loss. The vehicle characteristics identified may include vehicle make, model, age, height, weight, material, frame, and/or mileage.

In another aspect, a computer system configured to treat a vehicle damaged in a crash may be provided. The computer system may include one or more local or remote processors, servers, sensors, and/or transceivers configured to: (1) receive before a vehicle is damaged in a crash, pre-crash information about the vehicle; (2) input before the vehicle is damaged in a crash, the pre-crash information about the vehicle into a machine learning program trained to identify a treatment complexity level associated with treating the vehicle after a crash based upon the received pre-crash information, the treatment complexity level including a value of the vehicle and a price schedule for treating the damaged vehicle, wherein treating the damaged vehicle includes repairing, salvaging, or scrapping the damaged vehicle; (3) select a treatment facility for treating the vehicle based upon the determined treatment complexity level; and/or (4) transmit information associated with transporting the damaged vehicle to the selected treatment facility, with the customer's permission, to facilitate expediting the total loss processing.

The computer system may be further configured to: input depersonalized historical auto claim data (or auto claim data with customer permission or affirmative consent) into the machine learning program to train it to identify the treatment complexity level associated with treating an individual vehicle after a crash based upon the corresponding or received pre-crash information.

In another aspect, a computer system configured to process a vehicle damaged in a crash may be provided. The computer system may include one or more local or remote processors, sensors, servers, and/or transceivers configured to: receive before receiving notice of a vehicle being damaged in a crash, pre-crash information about the vehicle; input before receiving notice of the vehicle being damaged in a crash, the pre-crash information about the vehicle into a machine learning program trained to identify whether a likelihood of a total loss of the damaged vehicle is greater than a predetermined threshold based upon the received pre-crash information, wherein the total loss of the damaged vehicle comprises a cost of treating the damaged vehicle based upon a price schedule for treating the damaged vehicle being greater than a predetermined percentage of a value of the vehicle independent of a severity of actual damage after the vehicle is damaged in a crash; receive notice of the vehicle being damaged in a crash, the notice comprising an insurance claim for the damage to the vehicle; and/or automatically offer an insurance settlement for an insured value of the damaged vehicle if the likelihood of a total loss of the damaged vehicle is greater than the predetermined threshold, the insurance settlement comprising a value for a total loss of the vehicle independent of the severity of actual damage after the vehicle is damaged in the crash, to facilitate expediting total loss processing.

The computer system may be further configured to: input depersonalized historical auto claim data (or auto claim data with customer permission or affirmative consent) into the machine learning program to train it to identify whether a likelihood of a total loss of the damaged vehicle is greater than a predetermined threshold based upon the received pre-crash information.

The foregoing computer systems may be configured to have additional, less, or alternate functionality, including that discussed elsewhere herein. The foregoing computer systems may implemented via computer-executable instructions stored on non-transitory computer-readable media or medium. The computer systems may be implemented via computer-implemented methods via one or more local or remote processors, sensors, servers, and/or transceivers.

### Additional Considerations

Unless specifically stated otherwise, discussions herein using words such as “processing,” “computing, ” “calculating, ” “determining, ” “presenting, ” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Although the preceding text sets forth a detailed description of numerous different embodiments, it should be understood that the legal scope of the invention is defined by the words of the claims set forth at the end of this patent. The detailed description is to be construed as example only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f). The patent claims at the end of this patent application are not intended to be construed under 35 U.S.C. § 112(f) unless traditional means-plus-function language is expressly recited, such as “means for” or “step for” language being explicitly recited in the claim(s).

The systems and methods described herein are directed to an improvement to computer functionality, and improve the functioning of conventional computers” or the like.

1. A method, implemented on a computer system including one or more processors, for determining a treatment for a vehicle, the method comprising:
receiving, by the one or more processors, classification data representing a type of the vehicle, prior to the vehicle being involved in a crash, wherein the classification data includes at least one of a make, a model, or a year of manufacture;
receiving, by the one or more processors, telematics data representing driving characteristics of an operator of the vehicle, prior to the vehicle being involved in the crash;
identifying, by the one or more processors, vehicles having a similar vehicle type as the vehicle based upon the classification data, and similar driving characterizations as the driving characteristics of the operator of the vehicle based upon the telematics data;
analyzing, by the one or more processors prior to the crash, known vehicle damage associated with the identified vehicles to estimate a likely amount of damage to the vehicle if the vehicle is involved in the crash;
determining, , by the one or more processors prior to the crash, whether, based upon a value of the vehicle and the estimated likely amount of damage to the vehicle, the vehicle would likely be a total loss if the vehicle is involved in the crash;
automatically selecting, after the vehicle is damaged in the crash and when it was determined, prior to the crash, that the vehicle would likely be a total loss, a scrapping or salvaging facility for treating the vehicle; and
automatically transmitting, after the vehicle is damaged and when it was determined, prior to the crash, that the vehicle would likely be a total loss, information associated with directly transporting the vehicle to the selected scrapping or salvaging facility to a vehicle transporter, the vehicle transporter to transport the vehicle to the scrapping or salvaging facility in response to the information.

2. The method of claim 1, further comprising determining a likely cost of treating the vehicle if the vehicle is involved in the crash, wherein it is determined that the vehicle would likely be a total loss when the likely cost of treating the vehicle is greater than a predetermined percentage of the value of the vehicle independent of a severity of actual damage after the vehicle is damaged in a crash.

3. The method of claim 1, further comprising:
receiving actual crash information for the vehicle for the crash;
determining, by the one or more processors after the vehicle is damaged in the crash and when it was determined, prior to the crash, that the vehicle would likely not be a total loss, a post-crash treatment complexity level associated with treating the vehicle based upon the received actual crash information; and
selecting, by the one or more processors after the vehicle is damaged in the crash, a treatment facility for treating the vehicle based upon the determined post-crash treatment complexity level.

4. The method of claim 2, wherein estimating the likely cost of treating the vehicle is based upon a price schedule for treating the vehicle, wherein the price schedule comprises at least one of a storage cost for storing the vehicle, a rental cost while the vehicle is being treated, or a time duration for completing treatment of the vehicle, wherein determining whether the vehicle would likely be a total loss if the vehicle is involved in the crash is based upon the likely cost of treating.

5. (canceled)

6. The method of claim 4, wherein the price schedule for treating the vehicle is based upon past claim data for treating comparable vehicles damaged in a crash.

7. The method of claim 1, wherein the value of the vehicle comprises an actual cash value of the vehicle.

8. A non-transitory computer-readable media comprising machine-readable instructions that, when executed, cause a processor to:
receive classification data representing a type of the vehicle, prior to the vehicle being involved in a crash, wherein the classification data includes at least one of a make, a model, or a year of manufacture;
receive telematics data representing driving characteristics of an operator of the vehicle, prior to the vehicle being involved in the crash;
identify, prior to the crash, vehicles having a similar vehicle type as the type of the vehicle based upon the classification data, and similar driving characterizations as the driving characteristics of the operator of the vehicle based upon the telematics data;
analyze, prior to the crash, known vehicle damage associated with the identified vehicles to estimate a likely amount of damage to the vehicle if the vehicle is involved in the crash;
determine, prior to the crash, whether, based upon a value of the vehicle and the estimated likely amount of damage to the vehicle, the vehicle would likely be a total loss if the vehicle is involved in the crash;
receive, after the crash, a notice of the vehicle being damaged in the crash, the notice including an insurance claim for the damage to the vehicle in the crash; and
automatically offer, when it was determined, prior to the crash, that the vehicle would likely be a total loss, an insurance settlement for an insured value of the damaged vehicle in response to receiving the notice, the insurance settlement including a value for a total loss of the vehicle independent of the severity of actual damage after the vehicle is damaged in the crash.

9. The non-transitory computer-readable media of claim 8, wherein the instructions, when executed, cause the processor to, in response to receiving the notice and when it was determined, prior to the crash, that the vehicle would likely be a total loss:
automatically select a treatment facility for scrapping or salvaging the damaged vehicle after receiving the notice; and
automatically transmit information associated with transporting the vehicle to the selected treatment facility.

10. The non-transitory computer-readable media of claim 8, wherein the instructions, when executed, cause the processor to determine a likely cost of treating based upon the likely amount of damage and a price schedule for treating the vehicle, the price schedule including at least one of a storage cost for storing the vehicle, a rental cost while the vehicle is being treated, or a time duration for completing treatment of the vehicle, wherein determining whether the vehicle would likely be a total loss if the vehicle is involved in the crash is based upon the likely cost of treating.

11. (canceled)

12. The non-transitory computer-readable media of claim 10, wherein the price schedule for treating the vehicle is based upon past claim data for treating the similar vehicles.

13. The non-transitory computer-readable media of claim 8, wherein the value of the vehicle includes an actual cash value of the vehicle.

14. A computer system for determining a treatment of a vehicle, the computer system comprising:
a first computing device including one or more processors;
one or more sensors operatively coupled to the one or more processors of the first computing device, the one or more sensors adapted to collect telematics data representing operating characteristics of an operator of the vehicle and facilitate providing the telematics data for the vehicle, prior to the vehicle being involved in a crash, to the first computing device;
a first communication module operatively coupled to the first computing device and wirelessly transmitting the telematics data to a second computing device;
the second computing device including one or more processors;
one or more memory devices operatively coupled to the one or more processors of the second computing device, the one or more memory devices storing executable instructions that, when executed by the one or more processors of the second computing device before the vehicle is damaged in the crash, cause the second computing device to:
identify, prior to the crash vehicles comparable to the vehicle based upon the classifying information for the vehicle and having operating characteristics similar to the operating characteristics of the operator of the vehicle based upon the telematics data;
evaluate, prior to the crash, known vehicle damage for the identified vehicles to estimate a likely amount of damage to the vehicle, if the vehicle is involved in the crash; and
determine, prior to the crash, whether a total loss of the vehicle would be likely if the vehicle is involved in the crash in the future based upon a value of the vehicle and the estimated likely amount of damage to the vehicle; and
a second communication module operatively coupled to the second computing device and adapted to transmit information to a vehicle transporter associated with transporting the vehicle to a selected treatment facility after the vehicle is damaged in the crash, wherein selection of the treatment facility is in response to the determination, prior to the crash, that a total loss of the vehicle would be likely if the vehicle is involved in the crash.

15. (canceled)

16. The computer system of claim 14, wherein determining, prior to the crash, whether a total loss of the vehicle would be likely includes determining whether a likely cost of treating the vehicle is greater than a predetermined percentage of a value of the vehicle independent of a severity of actual damage after the vehicle is damaged in a crash, and wherein selection of the treatment facility includes selection of a treatment facility for scrapping or salvaging the vehicle.

17. The computer system of claim 16, wherein the executable instructions, when executed by the one or more processors of the second computing device after the vehicle is damaged in the crash, cause the second computing device to:
receive actual crash information for the vehicle;
determine, if it was determined, prior to the crash, that the vehicle would likely not be a total loss, a post-crash treatment complexity level associated with treating the vehicle based upon the received actual crash information; and
select a treatment facility for treating the vehicle based upon the determined post-crash treatment complexity level.

18. The computer system of claim 14, wherein determining, prior to the crash, whether the vehicle would likely be a total loss includes determining a likely treatment complexity based upon a price schedule for treating the vehicle, the price schedule comprising at least one of a storage cost for storing the vehicle, a rental cost while the vehicle is being treated, or a time duration for completing treatment of the vehicle.

19. (canceled)

20. The computer system of claim 18, wherein the price schedule for treating the vehicle is based upon past claim data for treating the comparable vehicles damaged in a crash.

21. The computer system of claim 16, wherein the value of the vehicle comprises an actual cash value of the vehicle.

22. A computer system for determining a treatment of a vehicle, the computer system comprising:
a computing device including one or more processors;
one or more telematics sensors operatively coupled to the one or more processors adapted to monitor operating characteristics of an operator of the vehicle, the one or more sensors capable of gathering telematics information for the vehicle before the vehicle is damaged in a future crash;
an analyzer operatively coupled to the one or more processors adapted to identify a plurality of vehicles having a same vehicle type as the vehicle, and estimate beforehand a likely amount of damage to the vehicle if the vehicle is involved in the future crash, based upon known vehicle damage for the plurality of vehicles having the same vehicle type as the vehicle, wherein the vehicle type includes at least one of a make, a model, or a year of manufacture;
a memory operatively coupled to the one or more processors, the memory storing executable instructions that, when executed by the one or more processors before the vehicle is involved in the future crash, cause the computer system to determine, prior to the future crash, whether, based upon a value of the vehicle and the estimated likely amount of damage to the vehicle, the vehicle would likely be a total loss if the vehicle is involved in the future crash; and
a communication module operatively coupled to the one or more processors adapted to transmit information associated with transporting the vehicle to a selected treatment facility after the vehicle is damaged in the crash, wherein a scrapping or salvaging treatment facility is automatically selected, after the crash, when it was determined, prior to the future crash, that the vehicle would likely be a total loss if the vehicle is involved in the future crash.

23. The method of claim 1, wherein automatically selecting, after the crash, the scrapping or salvaging facility for treating the vehicle when the likely total loss of the vehicle was determined prior to the crash is performed without assessing damage to the vehicle.

24. The method of claim 1, wherein analyzing, prior to the crash, the likely amount of data includes a plurality of crash types.

25. A computer-implemented method for determining a treatment for a vehicle involved in a crash, the method comprising:
prior to the vehicle being involved in a crash:
identifying vehicles that are comparable to the vehicle;
receiving telematics data representing driving characteristics of an operator of the vehicle;
determines a subset of the comparable vehicles having driving characteristics similar to the driving characteristics of the operator;
estimating a likely amount of damage to the vehicle if the vehicle is involved in the crash based upon known vehicle damage associated with the subset of the comparable vehicles; and
determining whether, based upon a value of the vehicle and the likely amount of damage to the vehicle, the vehicle would likely be a total loss if the vehicle is involved in the future crash; and
after the vehicle is involved in the crash, regardless of actual damage, and when it was determined the vehicle would likely be a total loss,
automatically instructing a vehicle transporter to transmit the vehicle to a scrapping or salvaging facility.
